(19) United States
(12) Patent Application Publication
(10) Pub. No.: US 2024/0410713 A1
(43) Pub. Date: Dec. 12, 2024

(54) REPAIR PLACE TRANSMISSION DEVICE AND REPAIR PLACE TRANSMISSION METHOD

(71) Applicant: Nissan Motor Co., Ltd., Kanagawa (JP)

(72) Inventors: Yuki Horihata, Kanagawa (JP); Toru Takagi, Kanagawa (JP)

(73) Assignee: Nissan Motor Co., Ltd., Kanagawa (JP)

(21) Appl. No.: 18/698,603

(22) PCT Filed: Oct. 8, 2021
(86) PCT No.: PCT/IB2021/000703

§ 371 Date: Apr. 4, 2024

(51) Int. Cl. G01C 21/36; G01C 21/34; G06Q 10/02; G06Q 10/087; G06Q 10/20

(52) U.S. Cl. CPC G01C 21/3682; G01C 21/3415; G01C 21/3438; G01C 21/3697; G06Q 10/02; G06Q 10/087; G06Q 10/20

(57) ABSTRACT

A repair place transmission device is configured to: acquire a movement schedule for moving a user to a destination using a vehicle; acquire a current location of the vehicle; an abnormality determination unit configured to determine whether or not an abnormality is present in the vehicle; extract, from the movement schedule, a travel route from the current location to the destination and a plurality of destinations located on the travel route; extract, for each of the destinations, a repair place for repairing the vehicle located within a predetermined range from the destination as the repair place corresponding to the destination when the abnormality is determined to be present in the vehicle; compute, for each of the repair places, an influence level indicating a level of influence on the movement schedule by repairing the vehicle in the repair place; and transmit a control signal for outputting repair place data on the repair place having a lower influence level in priority over repair place data on the repair place having a higher influence level.

### TECHNICAL FIELD

The present invention relates to a repair place transmission device and a repair place transmission method.

### BACKGROUND ART

Techniques for notifying a current location of a vehicle to a service center in the event of an abnormality occurring in a vehicle, transmitting location information of a repair center closest to the vehicle searched by the service center to the vehicle, and displaying a location of the repair center on a car navigation system of the vehicle are known in the art (see Patent Document 1).

### PRIOR ART DOCUMENT

### Patent Document

Patent Document 1: JP 2005-45501

### SUMMARY OF INVENTION

### Problems to be Solved by Invention

However, in the technique of Patent Document 1, the location of the repair center is displayed without considering a user's schedule. Therefore, for example, if a user stops by the displayed repair center and then goes to a destination, the user will be late for the original schedule, or the like. That is, there is a possibility of displaying a repair center affecting the user's schedule disadvantageously.

A problem to be solved by the present invention is to provide a repair place transmission device and a repair place transmission method capable of providing information on a repair place while suppressing influence on a user's schedule by repairing the vehicle.

### Means for Solving Problems

The present invention solves the above-mentioned problems by: acquiring a movement schedule for moving a user to a destination using a vehicle; acquiring a current location of the vehicle; extracting, from the movement schedule, a travel route from the current location to the destination; determining whether or not an abnormality is present in the vehicle; when the abnormality is determined to be present in the vehicle, extracting a plurality of repair places for repairing the vehicle within a predetermined range from the travel route; computing, for each of the repair places, an influence level indicating a level of influence on the movement schedule by repairing the vehicle at the repair place; and transmitting a control signal for outputting repair place data on the repair place having a lower influence level in priority over repair place data on the repair place having a higher influence level.

### Effects of Invention

According to the present invention, it is possible to provide information on the repair place while suppressing influence on the user's schedule by repairing the vehicle.

### BRIEF DESCRIPTION OF DRAWINGS

FIG. 1 is a configuration diagram illustrating an example of a repair place transmission device according to a first embodiment.

FIG. 2 is a diagram illustrating a specific example of a repair place display according to the first embodiment.

FIG. 3 is a flow chart illustrating an example of a sequence of a repair place transmission method according to the first embodiment.

FIG. 4 is a diagram illustrating a specific example of a display of failed part data according to a fourth embodiment.

FIG. 5 is a diagram illustrating an example of a repair place transmission device according to a fifth embodiment.

FIG. 6 is a flow chart illustrating a repair place transmission method according to the fifth embodiment.

FIG. 7 is a diagram illustrating a specific example of a display of a movable range according to the fifth embodiment.

FIG. 8 is a diagram illustrating a specific example of a display of a movable range according to the fifth embodiment

FIG. 9 is a diagram illustrating a specific example of a display of a movable range according to the fifth embodiment.

FIG. 10 is a flowchart illustrating an alternative movement means transmission method according to a sixth embodiment.

### MODE(S) FOR CARRYING OUT THE INVENTION

A repair place transmission device according to an embodiment of the present invention will now be described with reference to the accompanying drawings.

### First Embodiment

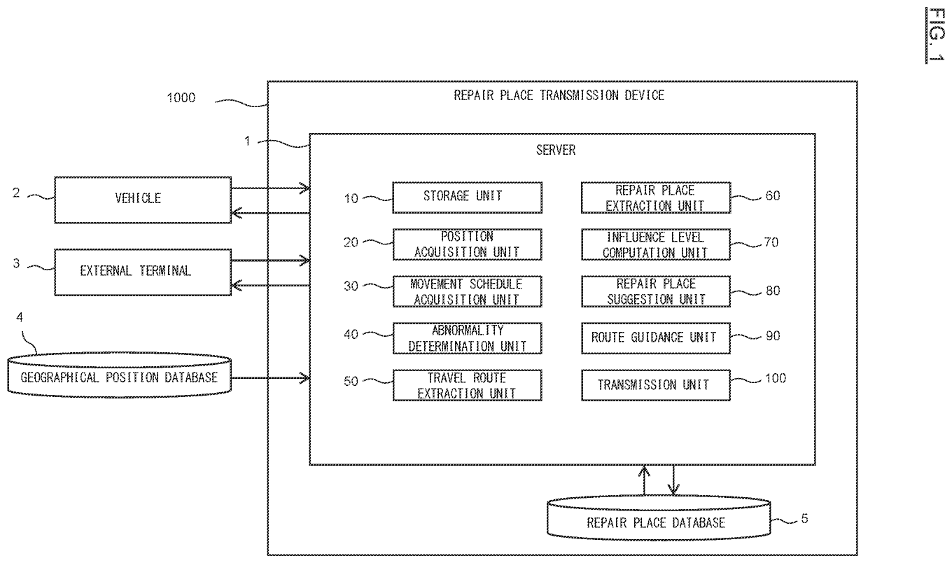

FIG. 1 is a configuration diagram illustrating an example of a repair place transmission device 1000 according to this embodiment. The repair place transmission device 1000 is a device that transmits, to a user's vehicle and/or external terminal, a control signal for outputting data on a repair place for repairing the vehicle in which an abnormality has occurred in case of the abnormality occurring in the vehicle driven to a user's destination on the basis of a movement schedule. As shown in FIG. 1, the repair place transmission device 1000 includes a server 1. In addition, the repair place transmission device 1000 is connected to a vehicle 2, an external terminal 3, and a geographical location database 4 via a network constituting an electric communication network. The repair place transmission device 1000 may be connected to a plurality of vehicles 2, a plurality of external terminals 3, or a plurality of geographical location databases 4. The external terminal 3 is a terminal device used by a user of the vehicle 2, and includes, for example, any device such as a smart phone or PC. The user includes a person who uses the vehicle 2, a person who owns the vehicle 2, and a person who manages the vehicle 2. The user may be either an individual or a corporation. The server 1 further includes a repair place database 5.

The server 1 includes a computer equipped with hardware and software, and this computer has a ROM that stores programs, a CPU that executes the program stored in the ROM, and a RAM that functions as an accessible memory device. Note that, as an operation circuit, MPU, DSP, ASIC, FPGA, or the like may be used instead of or together with the CPU.

When the server 1 determines that there is an abnormality in the vehicle 2, it estimates a movable range of the vehicle 2 at the time of determining that there is the abnormality. The movable range refers to a movable distance or movable time indicating a distance or time that the vehicle 2 can travel from the time it is determined that there is an abnormality to the occurrence of a failure caused by the abnormality of the vehicle 2 when the vehicle 2 is driven without repair. The server 1 extracts a repair place located within the movable range from the current location of the vehicle 2 as a repair place candidate on the basis of the estimated movable range. The number of extracted repair place candidates may also be multiple.

The vehicle abnormality refers to a state in which the vehicle is failed or a state that may lead to a vehicle failure. The abnormality of the vehicle includes either those that affect driving of the vehicle or those that do not affect driving of the vehicle. For example, the vehicle abnormality includes an engine failure that affects driving, or a power window failure that does not affect driving. The vehicle abnormality is defined by, for example, a failure code, such as a DTC code, that indicates an abnormality of a vehicle component. In addition, the vehicle abnormality includes a state in which a target part of the vehicle to be periodically replaced is not replaced.

The server 1 computes an influence level on the original schedule of the user and/or vehicle 2 when the vehicle 2 travels to a destination via the extracted repair place candidate, and determines a priority of the repair place candidate on the basis of the influence level. The influence level refers to a degree of influence on the original movement schedule of the user or vehicle 2 by repairing the vehicle 2 at the repair place. For example, the influence level is an index indicating a degree of time delay or extension of the travel distance caused by repair of the vehicle 2 and movement to the repair place with respect to the original schedule of the user or vehicle 2. The influence level is quantified by the difference between the time or distance on which the vehicle 2 travels to the destination via the repair place and the time or distance on which the vehicle 2 travels to the destination as originally scheduled without repair. The difference in time or distance includes, for example, a difference in the travel distance, travel time, and estimated arrival time.

In addition, the server 1 transmits, to the vehicle 2 and/or external terminal 3, a control signal for outputting repair place data of the repair place candidate and movable range data at the time of an abnormality. The repair place data of the repair place candidate includes location data of the repair place candidate. In addition, the repair place data may include a travel route to the repair place candidate. In addition, the server 1 may output, to the vehicle 2 and/or external terminal 3, the influence level of the repair place candidate and the priority determined on the basis of the influence level. Furthermore, the server 1 may display an executable schedule or task before repairing the vehicle 2 at the repair place candidate. For example, the server 1 outputs destination data regarding a destination stopped by before arriving at the repair place candidate.

The server 1 includes functional blocks such as a storage unit 10, a location acquisition unit 20, a movement schedule acquisition unit 30, an abnormality determination unit 40, a travel route extraction unit 50, a repair place extraction unit 60, an influence level computation unit 70, a repair place suggestion unit 80, a route guidance unit 90, and a transmission unit 100, and each function is executed through cooperation with software and hardware for realizing each of the above functions or executing each process. Note that, in this embodiment, functions of the server 1 are divided into 10 blocks, and the functions of each function block will be described. However, functions of the server 1 do not necessarily divided into 10 blocks, and may also be divided into 9 or less blocks, or 11 or more blocks.

The storage unit 10 acquires the repair place data on the repair place from the external geographical location database 4 and stores the repair place data on the repair place in the repair place database 5. The repair place data includes geographical location data indicating the location of the repair place, and name data such as a shop name of the repair place.

The location acquisition unit 20 acquires the current location data of the vehicle 2. The current location of vehicle 2 is expressed, for example, in latitude and longitude. The location acquisition unit 20 acquires the current location data of the vehicle 2 from a GPS or the like mounted on the vehicle 2. In addition, the location acquisition unit 20 may use current location data acquired from any device if it is a device that can acquire the current location of the vehicle 2, such as a car navigation of the vehicle 2 and a smartphone of the user riding in the vehicle 2 including a driver of the vehicle 2.

The movement schedule acquisition unit 30 acquires, from the vehicle 2 and/or external terminal 3, movement schedule data of the movement schedule in which a user moves to the destination using the vehicle 2, and stores the acquired movement schedule data. The movement schedule includes a start location of the vehicle 2, a destination, a travel route to the destination, a travel time to the destination, and an estimated arrival time of the vehicle 2 to the destination. A plurality of destinations may also be set on a single travel route. For example, the movement schedule may be a schedule on which that vehicle 2 moves to a second destination via a first destination.

The movement schedule acquisition unit 30 acquires movement schedule data from a schedule or a schedule management tool provided in the external terminal 3. The movement schedule acquisition unit 30 acquires movement schedule data on the basis of, for example, the external terminal 3 or the geographical location information registered in a map search service application installed on the external terminal 3. Specifically, the movement schedule acquisition unit 30 acquires the location data of the destination when the destination is registered in the schedule management tool of the external terminal 3. When home location data is registered in the map search service application, the movement schedule acquisition unit 30 acquires the location data of the home. In addition, when the movement schedule acquisition unit 30 acquires the location data of the destination, the travel route may be acquired by computing the travel route from the current location of the vehicle 2 to the destination. Furthermore, the movement schedule acquisition unit 30 acquires movement schedule data on the basis of the travel route to the destination registered in the car navigation device of the vehicle 2. Moreover, the movement schedule acquisition unit 30 may acquire a movement schedule via a POI having high travel frequency or stop-by frequency by acquiring a driving record or driving history recorded in the vehicle 2. Note that the number of movement schedule patterns to be acquired may be singular or multiple, and the movement schedule may be acquired from other information sources.

In addition, according to this embodiment, the movement schedule acquisition unit 30 automatically acquires the movement schedule from the user's schedule or schedule management tool. Instead, without limiting thereto, the movement schedule acquisition unit 30 may acquire the movement schedule input by the user manually on a navigation device of the vehicle 2 or external terminal 3. In addition, the movement schedule acquisition unit 30 may recognize a destination or the like through voice recognition from a conversation between the user and an agent or operator inside or outside the vehicle 2 to acquire the movement schedule. Furthermore, according to this embodiment, the acquisition condition for the movement schedule may be set arbitrarily. For example, the condition regarding acquisition of the movement schedule is whether or not the movement schedule is registered in a user terminal and a vehicle-mounted device. If it is determined that the movement schedule is not registered in the user terminal or the vehicle-mounted device, the movement schedule acquisition unit 30 acquires a movement schedule including a POI having higher travel frequency or stop-by frequency recorded in the vehicle 2 or a movement schedule to a registered place such as a home or workplace.

The abnormality determination unit 40 acquires vehicle data from the vehicle 2 and determines whether or not there is an abnormality in the vehicle 2. The vehicle data is data indicating a state of the vehicle 2, and specifically, is a detection result of the state of each part detected by the sensor installed on each part of the vehicle 2. The abnormality determination unit 40 acquires series data, for example, when engine rotation speed or engine temperature is included as the vehicle data. In addition, the abnormality determination unit 40 determines whether or not a failure occurs in the vehicle 2 or whether not a failure is likely to occur in the vehicle 2 in the future on the basis of the vehicle data. The abnormality determination unit 40 determines whether or not a sensor signal acquired from the vehicle data has an abnormal value out of a threshold value of each sensor signal on basis of the vehicle data and a predetermined detection condition. The abnormality determination unit 40 determines that there is an abnormality in the vehicle 2 if an abnormal value is detected. For the detection condition, corresponding failure codes and sensor signal thresholds are set for each sensor signal acquired from the vehicle data. The abnormality determination unit 40, for example, determines that the abnormal value is detected when the detected value of the sensor signal is out of the threshold range set in a predetermined range.

In addition, the abnormality determination unit 40 may perform invariant analysis. In the invariant analysis, the abnormality determination unit 40 builds a relationship model between a plurality of sensor signals from normal vehicle data and compares the value predicted from the model with an actual measurement value to detect whether or not the relationship model has collapsed. Furthermore, the abnormality determination unit 40 may determine a normal or abnormal state on the basis of the vehicle data using machine learning. The invention is not limited to the methods described above.

In addition, if it is determined that there is an abnormality in the vehicle 2, the abnormality determination unit 40 estimates a movable range of the vehicle 2 at the time of detecting the abnormality. Note that a single element or a plurality of elements may be used to estimate the movable range. An example for estimating the movable range using the movable distance will be described below.

The movable range using the movable distance is a difference obtained by subtracting the cumulative travel distance at the time of detecting an abnormality from the cumulative travel distance at the time that a failure is predicted in the vehicle 2 driven without repair. For example, the cumulative travel distance at the time of detecting an abnormality is set to 1200 km, and the cumulative travel distance at the time that a failure is predicted in the vehicle driven without repair is set to 1250 km. In this case, the movable range becomes 50 km by subtracting 1200 km from 1250 km.

In addition, the abnormality determination unit 40 is not limited to estimating the movable range at the time of detecting an abnormality, but may also estimate the movable range at a predetermined place on the travel route when driving to the predetermined place on the travel route. For example, the abnormality determination unit 40 may compute the movable range at the time that the vehicle 2 moves along the movement schedule and arrives at the destination on the travel route. In this case, it is conceivable that the cumulative travel distance at the time that the vehicle 2 arrives at the destination is longer than the cumulative travel distance at the time that a failure is predicted in the vehicle 2 driven without repair. In such a case, the abnormality determination unit 40 does not estimate the movable range as a negative value, but estimates it to be 0 km.

For example, assume that the cumulative travel distance at the time that the vehicle 2 arrives at the destination is 1300 km, and the cumulative travel distance at the time that a failure is predicted in the vehicle 2 driven without repair is 1250 km. In this case, the cumulative travel distance at the time that the vehicle 2 arrives at the destination is longer than the cumulative travel distance at the time that a failure is predicted to the vehicle 2 driven without repair. Therefore, the movable range is estimated to be 0 km. Note that the methods and values described here are merely examples and are not limited thereto. In addition, the movable range may be set as not only the movable distance but also an arbitrary index as long as it is a distance or time that can be expressed quantitatively, such as a usable time and an engine running time.

The travel route extraction unit 50 extracts the travel route from the current location to the destination from the movement schedule on the basis of the movement schedule and the current location of vehicle 2. The travel route extraction unit 50 may extract a destination located on the travel route from the current location, rather than the entire travel route. The travel route extraction unit 50 acquires location data of a destination located within the movable range of the vehicle 2 as destination data from the movement schedule, on the basis of the movable range at the time of abnormality detection. The destination data may be not only location data on a place of the destination, but also location data of a stopping place such as a parking lot or an edge of a cliff for stopping the vehicle 2 to visit the destination.

An example for acquiring a destination within the movable range will be described. In this example, it is assumed that the movable range is quantified as a movable distance. For example, in the movement schedule, the vehicle 2 is scheduled to move from the current location to the destination A, destination B, and destination C, sequentially. The movable range at the current location of the vehicle 2 (the location where an abnormality is detected) is set to 25 km. In addition, it is assumed that the movement distance from the current location to the destination A is 10 km, the movement distance from the destination A to the destination B is 7 km, and the movement distance from the destination B to the destination C is 13 km.

The travel route extraction unit 50 estimates the movable range for each destination by subtracting a total sum of the movement distances required to reach each destination from the movable distance at the time of detecting the abnormality. The travel route extraction unit 50 determines whether or not the movable range at each destination is longer than 0 km. If it is determined that this value is longer than 0 km, the travel route extraction unit 50 sets the travel route to the destination within a range of the value longer than 0 km as a movable route. If this value is determined to be shorter than 0 km, the travel route extraction unit 50 estimates the movable range to be 0 km. In the aforementioned example, the movable range for each destination is estimated as follows. The movable range at the destination A is 15 km, by subtracting 10 km from 25 km. The movable range at the destination B is 8 km, by subtracting 10 km and 7 km from 25 km. Since the movable range at the destination C becomes a negative value by subtracting 10 km, 7 km, and 13 km from 25 km, so the movable range is 0 km.

As a result, the movable range at the time of reaching the destination C becomes a negative value, and thus, the destination C is outside the movable range from the current location. Therefore, the travel route extraction unit 50 acquires location data of the destinations A and B within the movable range. Note that, in order to further reduce a possibility of the vehicle 2 failed during driving, the movable range threshold for extracting a destination within the movable range may not be set to 0 km, but may be set to an arbitrary positive value. As a result, it is possible to provide a margin for reducing the possibility of failure. Note that the method described here is merely an exemplary method, and the invention is not limited thereto.

After the abnormality determination unit 40 determines that there is an abnormality in the vehicle 2, the repair place extraction unit 60 extracts a repair place within a predetermined range from the travel route as a repair place candidate. The predetermined range is a range of distance or time computed by subtracting the movement distance or time from the current location to a predetermined place on the travel route from the movable distance or time at the current location. In addition, the predetermined range may be a range of the movable distance or time that the vehicle 2 can move from the current location until a failure caused by an abnormality in the vehicle 2 occurs. The repair place extraction unit 60 extracts a repair place located within the movable range at a predetermined place on the travel route as a repair place candidate, and acquires repair place data of the repair place candidate from the repair place database 5. A plurality of repair place candidates may be extracted. The predetermined place is, for example, the destination. That is, the repair place extraction unit 60 extracts a repair place located within the movable range for each destination as a repair place candidate from the repair place database 5 on the basis of the destination data acquired by the travel route extraction unit 50.

Here, an example of extraction of the repair place candidate will be described. The repair place extraction unit 60 extracts a repair place located within the movable range from each place for each current location and each destination. In the aforementioned example, the repair place extraction unit 60 extracts a repair place within a range of 25 km from the current location, a repair place within a range of 15 km from the destination A, and a repair place within a range of 8 km from the destination B as repair place candidates.

Note that the threshold for extracting the repair place candidate is not limited to a value of the movable range, and a value shorter than the value of the movable range may be set to the threshold. As a result, it is possible to provide a margin for reducing a possibility of the failure while the vehicle 2 is driven. For example, in the aforementioned example, when a value 5 km shorter than the value of the movable range is set as the threshold, the repair place extraction unit 60 extracts a repair place within a range of 20 km from the current location as the repair place candidate. Note that the method described here is an exemplary method, and the invention is not limited thereto.

In addition, the repair place extraction unit 60 computes a travel route for a case where the vehicle 2 moves from the current location via the destination and the repair place candidate(s) on the basis of the movement schedule, the destination, and the repair place candidate(s). In addition, the repair place extraction unit 60 computes the movement distance and time between each place on the travel route. The repair place extraction unit 60 may compute the movement time by assuming that the vehicle to be repaired is left at the repair place, and the user moves to a nearby destination, for example, by walking or by public transportation. When computing the movement time between each place, the repair place extraction unit 60 may acquire, for example, data of a map application, road traffic situation data such as congestion status and road speed limits, timetables of public transportation platforms (stations or bus stops) near the repair place candidate or the destination, and the like to compute the movement time.

The influence level computation unit 70 computes, for each repair place, an influence level indicating a degree of influence level on the movement schedule by repairing the vehicle 2 at the repair place. As an example of the influence level computation method, an example of influence level computation based on the travel distance from the current location to the destination will be described. According to this embodiment, first, the influence level computation unit 70 extracts, from the movement schedule, the travel distance in the original schedule in which the vehicle 2 travels to the destination without repair, that is, a first travel distance for a case where the vehicle 2 moves from the current location to the destination. For each repair place candidate, the influence level computation unit 70 computes the second travel distance for a case where the vehicle 2 travels from the current location to the destination via the repair place candidate. In addition, the influence level computation unit 70 compares the first and second travel distances for each repair place candidate, and computes the influence level of the repair place candidate having a large distance difference between the first and second travel distances to be higher than the influence level of the repair place candidate having a small distance difference between the first and second travel distances.

Hereinafter, the movement schedule, the travel route passing through each repair place candidate, and the movement distance between each place are assumed as follows. The movement schedule is a schedule for the vehicle 2 to move from the current location to destinations A and B, sequentially. The movable range of the vehicle 2 at its current location is 25 km. The first travel route is a travel route for repairing the vehicle 2 in the first repair place candidate around the current location, and is a route along which the vehicle 2 moves from the current location to the first repair place candidate, the destination A, and the destination B, sequentially. In addition, the second travel route is a travel route for repairing the vehicle 2 in the second repair place candidate around the destination A, and is a route along which the vehicle 2 moves from the current location to the destination A, the second repair place candidate, and the destination B, sequentially. The third travel route is a travel route for repairing the vehicle in the third repair place candidate around the destination B, and is a route along which the vehicle 2 moves from the current location to the destination A, the destination B, and the third repair place candidate, sequentially.

The distances between each place are set as follows. The movement distance from the current location to the destination A is 10 km, the movement distance from the destination A to the destination B is 7 km, the movement distance from the current location to the first repair place candidate is 5 km, the movement distance from the first repair place candidate to the destination A is 10 km, the movement distance from the destination A to the second repair place candidate is 3 km, the movement distance from the second repair place candidate to the destination B is 4 km, and the movement distance from the destination B to the third repair place candidate is 6 km.

In this example, the influence level computation unit 70 computes the influence level on the basis of the travel distance obtained when the vehicle 2 is repaired at a repair place from the current location (the place where an abnormality is detected), and reaches the destination B. The travel distance obtained when the vehicle 2 is repaired at a repair place from the current location (the place where an abnormality is detected) and reaches the destination B is a sum of the distances between each place on each travel route. In this example, the second travel distance in each travel route obtained by repairing the vehicle 2 and the first travel distance in the original travel route obtained by not repairing the vehicle 2 are computed as follows.
original travel route without repair: 10 km+7 km=17 km
first travel route: 5 km+10 km+7 km=22 km
second travel route: 10 km+3 km+4 km=17 km
third travel route: 10 km+7 km+6 km=23 km

The influence level for a case where the vehicle 2 is repaired at the repair place candidate is computed as a difference between the cumulative travel distance obtained by repairing the vehicle 2 and driving the vehicle 2 to the destination and the cumulative travel distance obtained by driving the vehicle 2 along the original travel route without repair. As the difference of the cumulative travel distance increases, the influence level on the original schedule of the user or vehicle 2 increases. In the example described above, the difference of the cumulative travel distance is computed as follows.
first travel route: 22 km−17 km=5 km
second travel route: 17 km−17 km=0 km
third travel route: 23 km−17 km=6 km

In this case, the third travel route has the highest influence level, and the second travel route has the lowest influence level. Using the aforementioned method, the influence level based on the cumulative travel distance is computed. Note that the methods and values described here are merely an example, and the invention is not limited thereto.

The repair place suggestion unit 80 determines the priority of the repair place candidate on the basis of the influence level. The repair place suggestion unit 80 determines priorities of a plurality of repair place candidates on the basis of the influence levels of each repair place candidate such that the priority increases in descending order of the influence level. The priority of each repair place candidate is determined using the influence level estimation example described above as follows.
priority 1: second travel route (influence level 0 km)
priority 2: first travel route (influence level 5 km)
priority 3: third travel route (influence level 6 km)

Note that, when there are repair place candidates having the same influence level, the repair place suggestion unit 80 may determine the same priority. In addition, the repair place suggestion unit 80 may determine the priority of the repair place candidate by combining other evaluation criteria, such as the order of the word-of-mouth evaluation, the order of the movement distance, and the user's visit history (by setting a higher priority for the repair place candidate having a visit history). The priority may be determined by combining methods of other embodiments. In addition, the method described here is merely an example, and the invention is not limited thereto.

The route guidance unit 90 generates route guidance information to be displayed on the vehicle 2 and/or the external terminal 3. The route guidance information includes, for example, a location of the repair place candidate and a travel route to the repair place candidate. A display format of the route guidance information is image data of a display screen displayed on a display. In addition, the display format may be an output of audio information. For example, the route guidance unit 90 generates a selection screen to suggest a repair place candidate to the user when the priority of the repair place candidate is determined. The selection screen includes repair place data for each repair place candidate. The repair place data includes a location of the repair place and a travel route of the vehicle passing through the repair place. The travel route of the vehicle passing through the repair place includes a travel route from the current location to the repair place, and a travel route from the repair place to the destination. In addition, the selection screen includes, for each repair place candidate, the influence level, the priority, the movable range in the event of an abnormality, and an executable schedule or achievable task before repair in case of moving to the repair place candidate.

In addition, according to this embodiment, the route guidance unit 90 generates a selection screen on which the repair place data on the repair place having a higher priority is displayed with a higher priority than the repair place data on the repair place having a lower priority. For example, the route guidance unit 90 generates a selection screen that displays repair place candidates in association with the priorities. In addition, without limiting thereto, the route guidance unit 90 may generate a selection screen on which the repair place data on the repair place having a higher priority is displayed with a larger text size than that of the repair place data having a lower priority, or may generate a selection screen on which only the repair place data on the repair places having priorities higher than a certain rank are displayed.

In addition, when the user selects a repair place to be stopped by among a plurality of repair place candidates displayed on the selection screen, the route guidance unit 90 generates a reservation screen for reserving the selected repair place. The route guidance unit 90 may compute a reservation time for repair of the vehicle 2 on the basis of the estimated arrival time of the vehicle 2 at the selected repair place and generate a reservation screen including the reservation time.

The transmission unit 100 transmits a control signal for displaying the route guidance information generated by the route guidance unit 90 to the vehicle 2 and/or the external terminal 3. According to this embodiment, the transmission unit 100 transmits, to the vehicle 2 and/or external terminal 3, a control signal for outputting the repair place data of a repair place having a lower influence level in priority over the repair place data of a repair place having a higher influence level. For example, when the route guidance unit 90 generates a selection screen that displays the repair place data of a repair place having a higher priority in priority over the repair place data of a repair place having a lower priority, the transmission unit 100 transmits the control signal for displaying the generated selection screen to the vehicle 2 and/or the external terminal 3. In addition, the transmission unit 100 transmits a control signal for displaying a reservation screen generated by the route guidance unit 90 to the vehicle 2 and/or the external terminal 3.

Next, the vehicle 2 will be described. The vehicle 2 is an automobile equipped with a navigation device, and is a car whose driving is controlled by manned automatic control or manual control. In addition, when the vehicle 2 is managed by a service provider as a user, such as a carsharing vehicle, the vehicle 2 may be an unmanned vehicle capable of driving control through automatic control. The vehicle 2 has a navigation device, sets a travel route from the departure to the destination on the basis of the current location of the vehicle 2 and the user's input, and provides route guidance to the user. For example, the navigation device displays a map, a current location of the vehicle 2, a location of the destination, and the travel route on a display device provided in the navigation device.

In addition, when the navigation device receives route guidance information from the repair place transmission device 1000, it outputs the route guidance information. For example, when the navigation device acquires data of the selection screen or reservation screen including repair place data of the repair place from the repair place transmission device 1000, the navigation device displays the selection screen or reservation screen on the display. In addition, the navigation device may output route guidance information including repair place data using audio information. The vehicle 2 has a GPS device, detects the current location of the vehicle 2, and transmits it to the repair place transmission device 1000 periodically. In addition, the vehicle 2 has an in-vehicle sensor, detects conditions of each part of the vehicle 2, and transmits the vehicle data indicating the vehicle state detected by the in-vehicle sensor to the repair place transmission device 1000 periodically. In addition, the vehicle 2 records a driving history including information on the POI corresponding to the movement destination, and transmits the driving history to the repair place transmission device 1000.

Next, the external terminal 3 will be described. The external terminal 3 receives information input from a user and outputs information to the user. The external terminal 3 acquires the location data input by the user and transmits the location data to the repair place transmission device 1000. For example, when the user inputs the location of the scheduled destination on the installed map/local application or schedule management application, the external terminal 3 acquires geographical location data of the scheduled destination. In addition, when the external terminal 3 acquires data of the selection screen or reservation screen including repair place data from the repair place transmission device 1000, it displays the selection screen or reservation screen including repair place data on the display. In addition, the external terminal 3 may output the repair place data using audio information.

When there is a selection input by the user to select a repair place to be stopped by from the repair place candidates displayed on the selection screen, the navigation device or external terminal 3 transmits the repair place selected by the user to the repair place transmission device 1000. In addition, when the user confirms the reservation of the repair place on the reservation screen, the navigation device or external terminal 3 transmits reservation confirmation information to the repair place transmission device 1000.

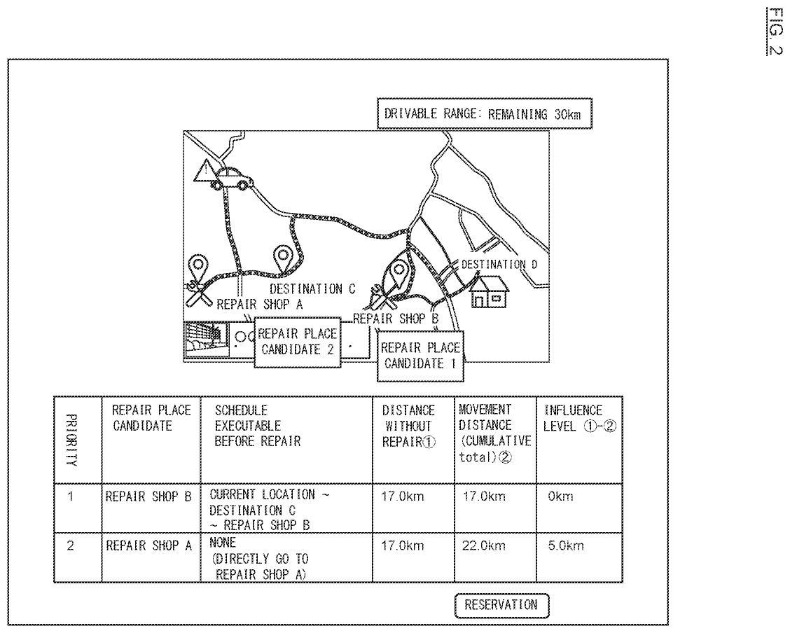

FIG. 2 is an example of the selection screen according to this embodiment. In FIG. 2, the selection screen displays, for example, the repair place candidate, the travel route to the repair place candidate, the influence level of the repair place candidate, the priority of the repair place candidate, a drivable range in the event of abnormality and a schedule or task executable before repair. FIG. 2 shows an original movement schedule in which the vehicle 2 moves to the destination C and the destination D sequentially. In addition, repair shops A and B are displayed as the repair place candidates. The repair shop B has an influence level of 0 km which is ranked 1st in priority, and the repair shop A has an influence level of 5.0 km which is ranked 2nd in priority. In addition, the drivable range in the event of an abnormality is displayed as 30 km. In the case of stopping by the shop B, the vehicle 2 moves from the current location to the shop B via the destination C. Therefore, the destination C is displayed as a schedule executable before repair.

The geographical location database 4 is a map database containing geographical location data. The geographical location data is, for example, data of latitude, longitude, and elevation. In addition, the geographical location data contains text information that becomes a label for a place name or toponym. The geographical location database 4 contains geographical location data of the POI. The geographical location database 4 contains, for example, location data of the destinations and the repair places.

The repair place database 5 is a database that stores repair place data relating to repair places. The repair place is a place for repairing or replacing parts of the vehicle 2, and includes, for example, a dealer's shop, a maintenance depot, a gas station, and the like. The repair place data includes, for each repair place, the location data of the repair place and data of the repair service provider. In addition, the repair place data includes, for example, the data of the repair place having the shop, the latitude and longitude of the place where the repair shop is located, and the repair shop name. In addition, the repair place data includes the latitude and longitude of the place of the repair service provider that does not have a shop but provides the repair service, and information on the repair service provider. The repair place data may include a reservation status and service hours of the repair place. Note that the repair place may be set in one or a plurality of places, and the information source of the repair place is arbitrary. In addition, the repair place data is generally automatically acquired by the storage unit 10 and stored in the repair place database 5. Instead, the repair place data may also be stored by registering it in the navigation device or the like manually by the user.

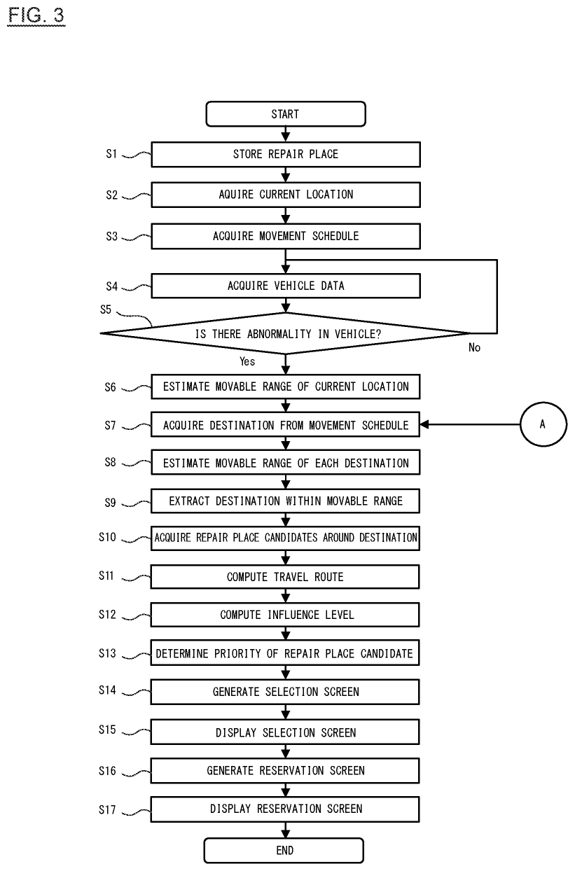

Next, the repair place transmission method executed by the repair place transmission device 1000 according to this embodiment will be described with reference to FIG. 3. FIG. 3 is a flow chart illustrating a sequence of the repair place transmission method according to the first embodiment. In step S1, the server 1 acquires repair place data of the repair place from the external geographical location database 4 and stores the repair place data in the repair place database 5. In step S2, the server 1 acquires the current location of the vehicle 2. In step S3, the server 1 acquires the movement schedule of the vehicle 2. For example, the server 1 acquires the original schedule of the user or vehicle 2 and acquires the movement schedule from the original schedule. In step S4, the server 1 acquires vehicle data.

In step S5, the server 1 determines whether or not there is an abnormality in the vehicle 2. For example, the server 1 determines, on the basis of the vehicle data of the vehicle 2, whether or not a failure occurs in the vehicle 2 or whether or not a failure is likely to occur in the vehicle 2 in the future. When the server 1 determines that a failure occurs in the vehicle 2 or a failure is likely to occur in the vehicle 2, it is determined that there is an abnormality in the vehicle 2. If it is determined that there is an abnormality in the vehicle 2, the server 1 proceeds to step S6. If it is determined that there is no abnormality in the vehicle 2, the server 1 proceeds to step S4 and repeats the flow described below. That is, the server 1 acquires vehicle data at predetermined intervals to determine whether or not there is an abnormality in the vehicle 2, until an abnormality in the vehicle 2 is detected.

In step S6, the server 1 estimates a movable range at the current location. In step S7, the server 1 acquires destination data of the destination from the movement schedule. In step S8, the server 1 estimates the movable range of each destination. The server 1 estimates the value obtained by subtracting the movement distance necessary for the vehicle 2 to arrive at the destination from the movable distance at the current location as the movable range of the destination. In step S9, the server 1 extracts a destination located within the movable range. In step S10, the server 1 acquires a repair place around the destination as the repair place candidate. For example, the server 1 acquires the repair place located within the movable range of the destination as the repair place candidate.

In step S11, the server 1 computes a travel route included in the original movement schedule and a travel route passing through each repair place candidate. In this case, the server 1 computes the movement distance and movement time between each place on the travel route. In step S12, the server 1 computes the influence level of each repair place candidate. In step S13, the server 1 determines the priority of each repair place candidate on the basis of the influence level. In step S14, the server 1 generates a selection screen for displaying the repair place data. The selection screen includes a location of the repair place, an influence level, a priority, a movable range in the event of an abnormality, a travel route for the vehicle 2 driven via the repair place candidate, and an executable schedule (movement schedule within the movable range) or an achievable task before repair.

In step S15, the server 1 transmits a control signal for displaying the generated selection screen to the vehicle 2 and/or external terminal 3. When the vehicle 2 and/or external terminal 3 receives the control signal, it displays the selection screen. In step S16, when the user selects a repair place, the server 1 generates a reservation screen for making a reservation for the selected repair place. In step S17, the server 1 transmits a control signal for displaying the reservation screen to the vehicle 2 and/or external terminal 3. When the vehicle 2 and/or external terminal 3 receives the control signal, the reservation screen is displayed.

As described above, in this embodiment, a user acquires a movement schedule for moving to a destination using a vehicle and acquires a current location of the vehicle. From the movement schedule, a travel route from the current location to the destination is extracted, and it is determined whether or not there is an abnormality in the vehicle. If it is determined that there is an abnormality in the vehicle, a plurality of repair places for repairing the vehicle are extracted within a predetermined range from the travel route. For each repair place, influence levels indicating a degree of influence on the movement schedule by repairing the vehicle at the repair places are computed. A control signal for outputting repair place data on the repair place having a lower influence level in priority over the repair place data on the repair place having a higher influence level is transmitted. As a result, it is possible to provide information on the repair place while suppressing influence of vehicle repair on the user's schedule.

In addition, in this embodiment, the first travel distance for driving the vehicle from the current location to the destination is extracted from the movement schedule. For each repair place, the second travel distance for driving the vehicle from the current location to the destination via the repair place is computed. For each repair place, the first travel distance and the second travel distance are compared. The influence level of the repair place having a larger distance difference between the first and second travel distances is computed to be higher than the influence level of the repair place having a smaller distance difference between the first and second travel distances. As a result, it is possible to provide the user with information on the influence on the user's schedule and the repair place capable of suppressing a burden of movement on the user. In addition, it is possible to reduce a failure possibility by shortening the travel distance.

In addition, in this embodiment, a plurality of destinations located on the travel route from the current location are extracted. As a result, by extracting the user's destination, it is possible to provide information on the repair place that matches the user's schedule. In addition, by extracting a plurality of destinations, it is possible to increase options for the repair place and the timing (time zone) for going to the repair place.

In addition, in this embodiment, the predetermined range is a distance or time range computed by subtracting the movement distance or movement time from the current location to a predetermined place on the travel route from the movable distance or movable time by which the vehicle can move until a failure caused by an abnormality occurs. As a result, it is possible to provide the user with information on the repair place at which the user can arrive before a failure occurs even when moving from a predetermined place of the movement schedule to the repair place. Therefore, it is possible to prevent a failure on the road and provide the user with a sense of relief.

In addition, in this embodiment, a repair place is extracted within a range of the movable distance or movable time by which the vehicle can move until a failure occurs due to an abnormality in the vehicle. As a result, it is possible to provide the user with information on the repair places to which the vehicle can arrive before a failure occurs, prevent a failure on the road, and provide the user with a sense of relief.

In addition, in this embodiment, route guidance information including a travel route from the current location to the repair place and a travel route from the repair place to the destination is generated, and a control signal for outputting the route guidance information is transmitted. As a result, it is possible to allow the user to know the route to be taken when the vehicle is driven via the repair place.

In addition, in this embodiment, when the user selects the repair place to be stopped by among a plurality of the output repair places, a reservation screen is generated to make a reservation for the selected repair place, and a control signal for outputting the reservation screen is transmitted. As a result, it is possible to allow the user to make a reservation for the repair place the user wants to stop by.

In addition, in this embodiment, on the basis of the estimated arrival time of the vehicle arriving at the selected repair place, the reservation time for repair of the vehicle is computed, and a control signal for outputting the reservation time on the reservation screen is transmitted. As a result, it is possible to allow the user to reserve the repair place that the user wants to stop by at the time matching the schedule.

### Second Embodiment

Next, a second embodiment of the present invention will be described. The second embodiment is a modification of the first embodiment. The second embodiment has a configuration similar to that of the first embodiment and operates similarly to the first embodiment except that the repair place transmission device of the second embodiment is different from that of the first embodiment as described below. Thus, the description of the first embodiment will be appropriately referred to. Hereinafter, a configuration different from that of the first embodiment will be described. The configuration of this embodiment is different from that of the first embodiment in that the influence level computation unit 70 acquires the repair time for each repair place candidate and the estimated arrival time of each place, and computes the influence level as a quantified value (delay time from the original movement schedule).

According to the second embodiment, the influence level computation unit 70 acquires a desired arrival time to a destination desired by a user, and computes, for each repair place, an estimated arrival time for a vehicle 2 to arrive at the destination via the repair place. In addition, the influence level computation unit 70 computes a delay time for the desired arrival time on the basis of the estimated arrival time and the desired arrival time for each repair place, and computes the influence level of the repair place having a longer delay time to be higher than the influence level of the repair place having a shorter delay time. As a result, according to this embodiment, it is possible to display a repair place candidate while suppressing delay in the arrival time at the user's desired destination. In addition, it is possible to allow the user to know the influence on the schedule caused by repair of the vehicle 2 on the basis of the degree of delay from the estimated arrival time originally scheduled (when the vehicle moves without repair).

First, the influence level computation unit 70 acquires a repair time taken to repair the vehicle 2 for each repair place candidate. The influence level computation unit 70 may acquire the repair time from the contents of each service of the repair shops listed on a WEB site, or the like, or may acquire the repair time by querying the repair shop, for example, by sending a notification for confirming the time required for repair to the repair shop.

In addition, the repair time may include not only a time during which the vehicle 2 is actually repaired in the repair place candidate, but also a waiting time during which the vehicle 2 waits in the repair place candidate. The waiting time is a time caused by a reservation status of the repair place candidate, congestion (waiting time such as waiting for 30 minutes), and service hours. For example, if the arrival time is immediately before or after the end time of service hours, the vehicle 2 may be repaired on the next business day. Therefore, a time from the arrival time to a repair start time on the next day (for example, service open time) may be included in the waiting time. In this case, the influence level computation unit 70 acquires, for example, data on the reservation status, congestion status, business day, and service hours of the repair place candidate.

The influence level computation unit 70 acquires the estimated arrival time of each destination by assuming that the vehicle 2 is repaired in each repair place candidate on the basis of the repair time and the movement time taken to move along the travel route. In addition, the influence level computation unit 70 acquires the estimated arrival time of each destination that was originally scheduled (assuming that the vehicle 2 moves without repair). Note that the estimated arrival time may be extracted directly from the movement schedule acquired from movement schedule acquisition unit 30. For a destination that does not have an estimated arrival time registered in the movement schedule, the computation may be made using the movement time computed by the repair place extraction unit 60, the current time, and the estimated arrival time of any registered destination.

In addition, the repair time may change depending on conditions, such as a time zone, even in the same repair place. For example, when the waiting time is included in the repair time, the waiting time changes depending on the time zone. In this regard, the influence level computation unit 70 may first compute the estimated arrival time of the repair place candidate and then acquire the repair time corresponding to the estimated arrival time.

Here, an example of estimated arrival time acquisition will be described. The travel route when stopping by the repair place candidate, the movement time between each place, and the repair time are assumed as follows. The first travel route is a route obtained by assuming that the vehicle 2 is repaired at a repair place candidate around the current location, and is a route along which the vehicle 2 moves from the current location to the first repair place candidate, destination A, destination B, and destination C, sequentially. In addition, the second travel route is a route obtained by assuming that the vehicle 2 is repaired at a repair place candidate around the destination A, and is a route along which the vehicle 2 moves from the current location to the destination A, second repair place candidate, destination B, and destination C, sequentially. The third travel route is a route obtained by assuming that the vehicle 2 is repaired at a repair place candidate around the destination B, and is a route along which the vehicle 2 moves from the current location to the destination A, destination B, third repair place candidate, and destination C, sequentially. The fourth travel route is a route in which the vehicle 2 is repaired in the repair place candidate after arriving at the destination C, and is a route along which the vehicle 2 moves from the current location to the destination A, destination B, destination C, and the fourth repair place candidate, sequentially. The movement times between each place are set as follows.
movement time from current location to destination A: 20 minutes
movement time from destination A to destination B: 14 minutes
movement time from destination B to destination C: 17 minutes
movement time from current location to first repair place candidate: 10 minutes
movement time from first repair place candidate to destination A: 20 minutes
movement time from destination A to second repair place candidate: 6 minutes
movement time from second repair place candidate to destination B: 8 minutes
movement time from destination B to third repair place candidate: 12 minutes
movement time from third repair place candidate to destination C: 10 minutes
movement time from destination C to fourth repair place candidate: 7 minutes In addition, the repair times of each repair place candidate are set 2 hours for the first, third, and fourth repair place candidates, and 3 hours for the second repair place candidate.

In the above example, it is assumed that the current time at the time of detection of an abnormality is 15:00, and a reservation or appointment at the destination B at 18:00 is registered in the user's schedule. For a destination for which there is no registered estimated arrival time, the estimated arrival time is computed using the estimated arrival time of the other destination and the movement time between each place. As a result, in the above example, the travel route in the case of no repair and the estimated arrival time at each place are computed as shown in Table 1.

TABLE 1
Travel route in case of no repair

| | Current | Destination | Destination | Destination |
|---|---|---|---|---|
| Travel route | location | A | B | C |
| Estimated | 15:00 | 15:20 | 18:00 | 18:17 |
| arrival time | (departure) | | | |

In addition, when the schedule of the user or vehicle 2 includes the required time or staying time at each place, the influence level computation unit 70 may compute the estimated arrival time in consideration of the required time or staying time.

Next, the influence level computation unit 70 acquires the estimated arrival time at each destination when repairing the vehicle 2 at each repair place candidate. The acquisition method of the estimated arrival time is similar to the acquisition method in case of no repair. Note that, when the estimated arrival time for which the vehicle 2 visits the repair place is later than the estimated arrival time registered in the schedule of the user or vehicle 2, the estimated arrival time is updated to that for which the vehicle 2 visits the repair place. Through this process, the estimated arrival time for each travel route is set as shown in Table 2.

TABLE 2

First travel route

| | Current | First repair place | | | |
|---|---|---|---|---|---|
| Travel route | location | candidate | Destination A | Destination B | Destination C |
| Estimated | 15:00 | 15:10 | 17:30 | 18:00 | 18:17 |
| arrival time | (departure) | | | | |

Second travel route

| | Current | | Second repair place | | |
|---|---|---|---|---|---|
| Travel route | location | Destination A | candidate | Destination B | Destination C |
| Estimated | 15:00 | 15:20 | 15:26 | 18:34 | 18:51 |
| arrival time | (departure) | | | | |

Third travel route

| | Current | | | Third repair place | |
|---|---|---|---|---|---|
| Travel route | location | Destination A | Destination B | candidate | Destination C |
| Estimated | 15:00 | 15:20 | 18:00 | 18:12 | 20:22 |
| arrival time | (departure) | | | | |

Fourth travel route

| | | | | | Fourth | |
|---|---|---|---|---|---|---|
| | Current | Destination | Destination | Destination | repair place | Destination |
| Travel route | location | A | B | C | candidate | C |
| Estimated | 15:00 | 15:20 | 18:00 | 18:17 | 19:24 | 21:31 |
| arrival time | (departure) | | | | | |

Note that the influence level computation unit 70 may obtain the estimated arrival time at each place by considering the business hours of the repair place candidate. For example, when the estimated arrival time for the repair place candidate is out of the business hours, the work start becomes the service open time of the next day. Therefore, the influence level computation unit 70 may acquire the service open time of the next day as the estimated arrival time.

In addition, when the influence level computation unit 70 acquires the desired arrival time from the schedule of the user or vehicle 2, the desired arrival time having higher importance may be acquired with a higher priority. For example, the influence level computation unit 70 acquires the desired arrival time of a destination that includes a word estimated to have higher importance in text information associated with the desired arrival time of the schedule. The word estimated to have higher importance includes, for example, “hospital”, “medical examination”, “dentist”, and the like.

Next, the influence level computation unit 70 computes the influence level for each travel route. The influence level computation unit 70 computes the influence level, for example, by computing the delay time for the estimated arrival time at any destination. The influence level computation unit 70 computes the influence level as “0” when no delay occurs, and computes the influence level higher as the delay time increases. The influence level is the delay time based on the estimated arrival time when the vehicle 2 arrives at the destination without repair. In this example, the influence level computation unit 70 computes the influence level based on the estimated arrival time of the destination C. Instead, without limiting thereto, the influence level may be computed for two or more arbitrary destinations. The estimated arrival time and influence level of the destination C are set as follows. Note that the method of computing the estimated arrival time by the influence level computation unit 70 described above and the method of computing the influence level as a quantified value (delay time) are merely an example, and the invention is not limited thereto.
travel route in case of no repair: estimated arrival time 18:17
first travel route: estimated arrival time 18:17 (influence level 0 minutes)
second travel route: estimated arrival time 18:51 (influence level 34 minutes)
third travel route: estimated arrival time 20:22 (influence level 2 hours 3 minutes)
fourth travel route: estimated arrival time 21:31 (influence level 3 hours 14 minutes)

The repair place suggestion unit 80 determines the priority of the repair place candidate and the travel route to the repair place candidate on the basis of the influence level. The priority is highest when the influence level is 0, and decreases as the influence level increases. Here, for the priority based on the influence level, the 1st priority is the first travel route (influence level 0 minutes), the 2nd priority is the second travel route (influence level 34 minutes), the 3rd priority is the third travel route (influence level 2 hours 3 minutes), and the 4th priority is the fourth travel route (influence level 3 hours 14 minutes).

In the above example, the priority of the first travel route at an influence level of 0 minutes, where the estimated arrival time is unchanged, is the highest, and the priority of the fourth travel route at an influence level of 3 hours 14 minutes is the lowest. Note that, according to this embodiment, the priority is determined on the basis of the influence level in the destination C, but without limiting thereto, the priority determination condition for the estimated arrival times of a specific place or all places may be arbitrarily set. For example, the priority of the travel route that is late to the desired arrival time of the schedule of the user or vehicle 2 may be set to the lowest level. Under this condition, in the above example, the 1st priority is the first travel route, the 2nd priority is the third travel route, the 3rd priority is the fourth travel route, and the 4th priority is the second travel route where there is a delay in the desired arrival time for the destination B.

In addition, the destination that serves as a reference for obtaining the priority may be set arbitrarily as long as it is at least one place among the destinations that are set as a reference for computing the influence level. When there are a plurality of destinations that serve as the reference for obtaining the priority, it may be derived by any method as long as the priority increases as the influence level decreases, such as a total sum of the influence levels of each place. In addition, the method described here is merely an example, and the invention is not limited thereto.

According to this embodiment, in step S12 of the repair place transmission method in FIG. 3, when the server 1 computes the influence level, the repair time of each repair place candidate and the estimated arrival time of each place are acquired, and the influence level is computed using the delay time with respect to the original movement schedule.

As described above, according to this embodiment, the desired arrival time to the destination desired by the user is acquired. For each repair place, the estimated arrival time for the vehicle to arrive at the destination via the repair place is computed. For each repair place, the delay time for the desired arrival time is computed on the basis of the estimated arrival time and the desired arrival time, and the influence level of the repair place having a longer delay time is computed to be higher than the influence level of the repair place having a shorter delay time. As a result, it is possible to suppress a delay in the arrival time at the destination desired by the user. In addition, from the delay time to the estimated arrival time that was originally scheduled (based on the movement schedule in case of no repair), it is possible to allow the user to more quantitatively and specifically know the influence on the user's schedule.

### Third Embodiment

Next, a third embodiment of the present invention will be described. The third embodiment is a modification of the second embodiment. The third embodiment has a configuration similar to that of the second embodiment and operates similarly to the second embodiment except that the repair place transmission device of the third embodiment is different from that of the second embodiment as described below. Thus, the description of the second embodiment will be appropriately referred to. Hereinafter, a configuration different from that of the second embodiment will be described. The configuration of this embodiment is different from that of the second embodiment in that the influence level computation unit 70 computes the influence level on the basis of a comparison result between a staying time of each destination and a repair time of the corresponding repair place candidate.

According to the third embodiment, the repair place extraction unit 60 extracts, for each destination, a repair place located within a predetermined range from the destination as a repair place corresponding to the destination. The influence level computation unit 70 acquires, for each destination, the user's staying time at the destination, and acquires the repair time required for repair of the vehicle 2 for each repair place. In addition, for each destination, the influence level computation unit 70 compares the staying time at the destination with the repair time at the corresponding repair place, computes the influence level of the repair place whose repair time is longer than the staying time to be higher than the influence level of the repair place having a repair time shorter than staying time. In this embodiment, it is assumed that the user requests repair of the vehicle 2 to the repair place and then moves to a nearby destination to complete a user's task while the vehicle 2 is repaired. In this case, assuming that the repair time is longer than the staying time, the schedule is affected because it is necessary to wait until the repair of the vehicle 2 is completed even after the user finishes the task at the destination.

The influence level computation unit 70 may acquire the repair time including the movement time between each place in addition to the time taken to actually repair the vehicle 2 and the waiting time at the repair place. The influence level computation unit 70 acquires the estimated departure time and estimated arrival time of each destination, and the estimated arrival time of the repair place candidate, by assuming that the vehicle 2 is repaired at each repair place candidate. In addition, the influence level computation unit 70 acquires the estimated departure time and estimated arrival time at each place by assuming that the vehicle 2 moves without repair. The method of acquiring the estimated arrival time is similar to that of the second embodiment.

The influence level computation unit 70 acquires an abnormality detection current time as the estimated departure time of the current location. The influence level computation unit 70 acquires the estimated departure time at the destination from the schedule of the user or vehicle 2. In addition, when the schedule of the user or vehicle 2 includes the time required for the user to execute a task at the destination or the staying time, the influence level computation unit 70 acquires the estimated departure time considering the required time or staying time at the destination. When the estimated departure time is not registered in the schedule, the influence level computation unit 70 acquires the estimated departure time of each destination by subtracting the movement time between each place from the estimated arrival time of the next place.

The influence level computation unit 70 estimates the staying time of the user or vehicle 2 at each destination on the basis of the repair time, the movement time between each place, the movement schedule, the estimated departure time, and/or the estimated arrival time.

For example, it is assumed that the schedule of the user or vehicle 2 includes a schedule for the vehicle 2 to arrive at the destination B at 18:00 and depart the destination B at 19:00. In this case, the travel route of the original movement schedule, and the estimated departure time and estimated arrival time of the travel route are set as shown in Table 3.

TABLE 3
Travel route of original movement schedule

| | Current | Destination | Destination | Destination |
|---|---|---|---|---|
| Travel route | location | A | B | C |
| Estimated | 15:00 | 17:45 | 19:00 | Next day |
| departure time | (departure) | | | 10:00 |
| Estimated | | 15:20 | 18:00 | 19:17 |
| arrival time | | | | |

In addition, when the estimated departure time is not included in the schedule of the user or vehicle 2, the influence level computation unit 70 may acquire an arbitrary time, such as the next day's operation time or commute time for a dispatch service, as the estimated departure time. In addition, the influence level computation unit 70 may acquire the time computed by subtracting the movement time from the destination to the repair place candidate from the next day's service open time in the repair place candidate around the destination as the estimated departure time. The method described here is merely an example, and the invention is not limited thereto. Using the same method, the estimated departure time for each repair place candidate may be also be computed and acquired arbitrarily.

Next, the influence level computation unit 70 estimates the staying time at each destination. For example, the influence level computation unit 70 estimates the time difference between the estimated departure time and the estimated arrival time acquired at each place as the staying time. The influence level computation unit 70 estimates the staying time at the destination A as 2 hours 26 minutes (15:20˜17:46), the staying time at the destination B as 1 hour (18:00˜19:00), and the staying time at the destination C as 14 hours 43 minutes (19:17˜10:00 of the next day). In addition, the method described here is merely an example, and the invention is not limited thereto.

For each destination, the influence level computation unit 70 computes the influence level of each repair place candidate on the basis of the staying time at the destination and the repair time of the repair place candidate corresponding to the destination. The influence level computation unit 70 computes the influence level of the repair place candidate by comparing the staying time at the destination and the repair time of the repair place candidate corresponding to the destination. The repair place candidate corresponding to the destination is, for example, a repair place candidate located within a predetermined range from the destination. The influence level computation unit 70 compares the staying time at the destination with the repair time of the repair place candidate corresponding to the destination. When the repair time is shorter than the staying time, the influence level of the corresponding repair place candidate is computed to be lower. In addition, when the repair time is shorter than the staying time, the influence level computation unit 70 may compute the influence level to be lower as the absolute value of the time difference between the staying time and the repair time increases. Meanwhile, the influence level computation unit 70 computes the influence level of the repair place candidate to be higher when the repair time is longer than the staying time. In addition, when the repair time is longer than the staying time, the influence level computation unit 70 may compute the influence level to be higher as the absolute value of the time difference between the staying time and the repair time increases.

Here, an example of a method for computing the influence level using the staying time and the repair time will be described. The travel route passing through each repair place candidate and the repair time of each repair place candidate are set as follows. The first travel route is a route for which the vehicle 2 is repaired using a repair place candidate around the current location, and is the route that the vehicle 2 travels from the current location to the first repair place candidate, destination A, destination B, and destination C, sequentially. In addition, the second travel route is a route for which the vehicle 2 is repaired using a repair place candidate around destination A, and the vehicle 2 travels from the current location to the destination A, second repair place candidate, destination B, and destination C, sequentially. The third travel route is a route for which the vehicle 2 is repaired at a repair place candidate around the destination B, and the vehicle 2 moves from the current location to the destination A, destination B, third repair place candidate, and destination C, sequentially. In addition, the fourth travel route is a route for which the vehicle 2 is repaired using a repair place candidate around the destination C, and the vehicle 2 moves from the current location to the destination A, destination B, destination C, fourth repair place candidate, and destination C, sequentially. The repair time of each repair place candidate is set to 2 hours for the first repair place candidate, 2 hours for the second repair place candidate, 2 hours for the third repair place candidate, and 3 hours for the fourth repair place candidate.

In the above example, the influence level computation unit 70 computes the influence level of each repair place candidate by comparing the repair time and the staying time by combining the repair time of the first repair place candidate and the staying time of the current location, the repair time of the second repair place candidate and the staying time of the destination A, the repair time of the third repair place candidate and the staying time of the destination B, and the repair time of the fourth repair place candidate and the staying time of destination C. The influence level of each repair place candidate is obtained as follows. Since the repair time of the first repair place candidate is 2 hours, the staying time of the current location is 0 minutes, and the staying time is 2 hours shorter than the repair time, the influence level computation unit 70 computes plus 2 hours as the influence level. Since the repair time of the second repair place candidate is 2 hours, the staying time of the destination A is 2 hours 26 minutes, and the staying time is 26 minutes longer than the repair time, the influence level computation unit 70 computes minus 26 minutes as the influence level. Since the repair time of the third repair place candidate is 2 hours, the staying time of the destination B is 1 hour, and the staying time is 1 hour shorter than the repair time, the influence level computation unit 70 computes plus 1 hour as the influence level. Since the repair time of the fourth repair place candidate is 3 hours, the staying time of the destination C is 14 hours 43 minutes, and the staying time is 11 hours 43 minutes longer than the repair time, the influence level computation unit 70 computes minus 11 hours 43 minutes as the influence level. As a result, the influence level of the fourth repair place candidate becomes the minimum, and the influence level of the first repair place candidate becomes the maximum.

In addition, the influence level computation unit 70 may compute the influence level by acquiring the estimated arrival time, repair time, and staying time by considering the repair place data. The repair place data contains the reservation status and business hours of the repair place candidate. For example, when the estimated arrival time to the repair place candidate is out of the business hours, or the vehicle 2 having the estimated arrival time of the repair place candidate set to the service open time of the next day cannot move to the repair place candidate within business hours, the repair time of this repair place candidate includes the user waiting time (until the next service open time). Therefore, the influence level computation unit 70 compares the repair time including waiting time with the staying time of the corresponding destination. In addition, the influence level computation unit 70 may compute the influence level obtained by considering the reservation status and business hours and an influence level obtained by not considering the reservation status and business hours. The method described here is merely an exemplary method, and the invention is not limited thereto.

In this embodiment, in step S12 of the repair place transmission method of FIG. 3, when the server 1 computes the influence level, the repair time of each repair place candidate and the estimated departure/arrival time of each place are acquired to estimate the staying time. In addition, the server 1 computes the influence level on the basis of the comparison result between the staying time of each destination and the repair time of the corresponding repair place candidate. As a result, the repair place having the shortest waiting time for the user can be proposed preferentially. Therefore, it is possible to improving user's time efficiency.

As described above, in this embodiment, a plurality of destinations located on the travel route are extracted. For each destination, a repair place located within a predetermined range from the destination is extracted as a repair place corresponding to the destination. For each destination, the user's staying time at the destination is acquired. For each repair place, the repair time required to repair the vehicle 2 is acquired. For each destination, by comparing the staying time at the destination and the repair time at the corresponding repair place, the influence level of the repair place having the repair time longer than the staying time is computed to be higher than the influence level of the repair place having the repair time shorter than the staying time. As a result, the time the user waits for repair of the vehicle 2 is shortened. Therefore, it is possible to improve user's time efficiency.

### Fourth Embodiment

Next, a fourth embodiment of the present invention will be described. The fourth embodiment is a modification of the third embodiment. The fourth embodiment has a configuration similar to that of the third embodiment and operates similarly to the third embodiment except that the repair place transmission device of the fourth embodiment is different from that of the third embodiment as described below. Therefore, the description of the third embodiment will be appropriately referred to. Hereinafter, a configuration different from that of the third embodiment will be described. The configuration of this embodiment is different from that of the third embodiment in that the abnormality determination unit 40 estimates a failed part, and the repair place extraction unit 60 acquires the inventory status of replacement parts for each repair place candidate.

According to the fourth embodiment, if it is determined that the vehicle 2 has an abnormality, the abnormality determination unit 40 estimates a failed part as a target of the abnormality. That is, the abnormality determination unit 40 specifies a replacement item necessary to repair the vehicle 2. For example, the abnormality determination unit 40 estimates a failed part on the basis of the vehicle data, the abnormality detection signal, and the movable range, and stores the failed part data indicating the estimated failed part. In addition, the estimated target part is not limited to the failed part, and may be, for example, a part whose replacement period has passed.

Here, an example of estimation of a failed part will be described. As an example of a method of estimating a failed part, an estimation method using a movable range will be described. The abnormality determination unit 40 first specifies a type of the abnormality when it is determined that there is an abnormality. The type of the abnormality is specified by a failure code. For each abnormality type, the part suspected as a cause of the abnormality is stored in the database as a failed part candidate. The abnormality determination unit 40 specifies the failed part candidate in associated with the abnormality type on the basis of the specified abnormality type. For example, the abnormality type is assumed to be “engine misfire”, and the movable range is assumed to be 80 km. The failed parts suspected as a cause of “engine misfire” are “spark plug,” “injector,” and “air sensor.”

In addition, the abnormality determination unit 40 estimates a failed part among the three parts by comparing the movable range with a statistically derived value of the timing (abnormality detection point) when a sign of failure appears among the signals of the vehicle 2 for the three parts. For example, when engine misfire occurs in the future, for the three parts, timings (abnormality detection point) at which a sign of engine misfire appears as a change in the signal behavior of the vehicle 2 are as follows. The spark plug has 30 km before a failure occurs, the injector has 75 km before an abnormality occurs, and the air sensor has 150 km before an abnormality occurs. In this case, the abnormality determination unit 40 estimates an injector having a movable range of 80 km and the closest abnormality detection point as a failed part. In addition, the method described here is merely an exemplary method, and the invention is not limited thereto.

The repair place extraction unit 60 extracts a repair place located within the movable range at the time of abnormality determination from repair place database 5, and acquires replacement item data regarding the replacement item of the failed part estimated by the abnormality determination unit 40 from the extracted repair place. The replacement item data includes data on the inventory status of the replacement item at the repair place and a lead time required for warehousing the replacement item. For example, in repair place extraction unit 60, it is okay to obtain replacement item data by inquiring about inventory status at the repair shop.

In addition, the repair place extraction unit 60 extracts, as the repair place candidate, a repair place having a replacement item in stock among repair places located within the movable range from the destination, on the basis of the acquired replacement item data of each repair place, and acquires the repair place data of the repair place candidate. In addition, the repair place extraction unit 60 may extract a repair place having a lead time of the replacement item shorter than a predetermined period as the repair place candidate. The predetermined lead time is, for example, within 1 hour or 1 day. In addition, the repair place extraction unit 60 may extract both a repair place having a replacement item in stock and a repair place having a lead time shorter than a predetermined period. The predetermined lead time may be set arbitrarily, or may be set separately for each part. In addition, for example, if the replacement item is a domestically produced item, the repair place candidate may be extracted on the basis of stock availability. If the replacement item is an overseas produced item, the repair place candidate may be extracted in consideration the lead time. That is, the extraction condition may be set for each part.

According to this embodiment, the influence level computation unit 70 computes the influence level of the repair place candidate on the basis of the inventory status and lead time of the replacement item at each repair place. First, the influence level computation unit 70 acquires the repair time including the lead time of the replacement item. The influence level computation unit 70 acquires the estimated arrival time of each destination visiting after repairing the vehicle 2 at the repair place candidate on the basis of the repair time including the lead time. The influence level computation unit 70 computes the influence level used in the delay time for the movement schedule on the basis of the acquired estimated arrival time at each destination. In addition, since the lead time may change depending on the estimated arrival time, the influence level computation unit 70 may acquire a repair time including the lead time corresponding to the acquired estimated arrival time. For example, it is assumed that the replacement item is delivered to the repair place candidate at 16:00. In this case, if the estimated arrival time is before 16:00, the influence level computation unit 70 acquires the repair time by adding a time difference from the estimated arrival time to 16:00 to the time relating to the repair itself. In addition, the influence level computation unit 70 may compute the influence level of the repair place candidate having no stock to be higher. Note that the method described here is merely an exemplary method, and the invention is not limited thereto.

The route guidance unit 90 generates a selection screen that displays the repair place data and the failed part data. In addition, the selection screen includes handling parts, influence levels, priorities, and inventory status for each repair place as the repair place data. The failed part data includes data on the name of the failed part and the cost of the replacement item. Furthermore, the failed part data may include data on the abnormality type and maintenance details.

The transmission unit 100 transmits a control signal for displaying a selection screen including the repair place data and the failed part data generated by the route guidance unit 90 to the vehicle 2 and/or external terminal 3.

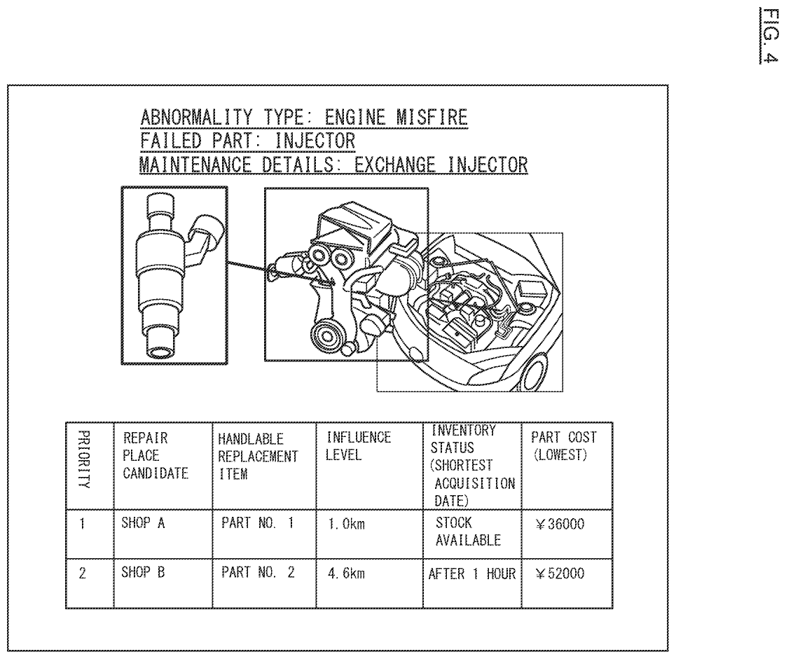

Next, a display example for displaying on the display of the vehicle 2 and/or external terminal 3 according to the fourth embodiment will be described with reference to FIG. 4. FIG. 4 is an example of a selection screen for displaying the repair place data and the failed part data. For example, as shown in FIG. 4, the selection screen displays a name of the failed part and a location of the failed part in the vehicle. In addition, the selection screen displays a product number of the replacement item for replacing the failed part, and the inventory status and cost of each replacement item. By displaying the cost of the part handled in the repair place candidate, the user can reserve a repair place taking cost into consideration.

According to this embodiment, when the server 1 acquires the repair place candidate in step S10 of the repair place transmission method in FIG. 3, the repair place candidate is acquired on the basis of the inventory status of each repair place candidate. In addition, in step S12, when computing the influence level, the server 1 acquires the repair time considering the lead time and computes the influence level. In step S14, the server 1 generates a selection screen including the failed part data.

As described above, according to this embodiment, the replacement item required to repair the vehicle is specified, and the repair place is extracted on the basis of the inventory status of the replacement item at each repair place and the period necessary to receive the replacement item. In addition, the influence level of the repair place is computed on the basis of the inventory status of the replacement items at each place and the period necessary to receive the replacement item. As a result, it is possible to determine influence of the inventory status of the replacement item on the user's schedule and provide the user with information on the repair place having a priority more accurately.

In addition, according to this embodiment, a control signal for outputting replacement item data for a specific replacement item is transmitted. As a result, it is possible to allow the user to determine a detected abnormal condition and cause of the vehicle.

### Fifth Embodiment

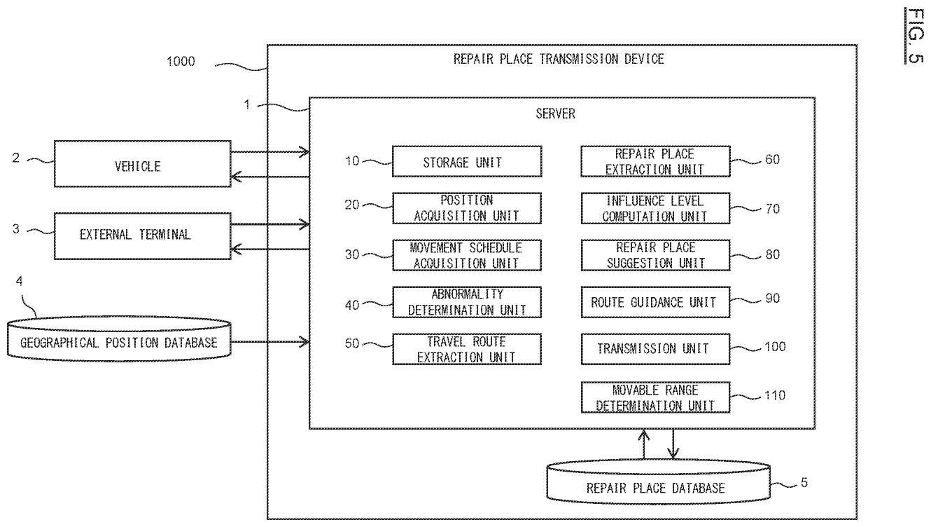

Next, a fifth embodiment of the present invention will be described. FIG. 5 is a block diagram illustrating a repair place transmission device according to this embodiment. The fifth embodiment is a modification of the fourth embodiment. The fifth embodiment has a configuration similar to that of the fourth embodiment and operates similarly to the fourth embodiment except that the repair place transmission device of the fifth embodiment is different from that of the fourth embodiment as described below. Therefore, the description of the fourth embodiment will be appropriately referred to. Hereinafter, a configuration different from that of the fourth embodiment will be described. The configuration of this embodiment is different from that of the fourth embodiment in that the server 1 further has a movable range determination unit 110.

According to the fifth embodiment, while the user confirms the reservation of the repair place on the reservation screen, and then the vehicle 2 is driven along the travel route passing through the repair place, the movable range determination unit 110 acquires the movable range at that time periodically. On the basis of the movable range and the movement distance or time from the current location of the vehicle 2 to the repair place, it is determined whether or not the reserved repair place is located within the movable range. That is, according to this embodiment, while the vehicle 2 is driven, it is determined whether or not the vehicle 2 can arrive at the repair place within the remaining movable range.

The movable range determination unit 110 acquires the current location of the vehicle 2 periodically after the user confirms the reservation of the repair place. Then, the movable range determination unit 110 computes the travel route from the time of confirming the reservation of the repair place to the current location of the vehicle 2 as an actual travel route. In addition, the movable range determination unit 110 acquires a reference movement range necessary for the vehicle 2 to arrive at the reserved repair place from the current location. The reference movement range is the movement distance or movement time necessary for the vehicle 2 to arrive at the repair place from the current location.

The movable range determination unit 110 acquires the movable range at the current location of the vehicle 2 periodically after the user confirms the reservation of the repair place on the basis of the actual travel route and the movable range at the time of confirming the reservation of the repair place. The movable range estimation method is similar to that of the abnormality determination unit 40.

The movable range determination unit 110 compares the movable range and the threshold periodically and determines whether or not the reserved repair place is located within the movable range depending on whether the movable range is equal to or longer than the threshold. If the movable range is equal to or longer than the threshold, the movable range determination unit 110 determines that the reserved repair place is located within the movable range. If the movable range is shorter than the threshold, the movable range determination unit 110 determines that the reserved repair place is not located within the movable range. The threshold is, for example, the reference movement range obtained by the movable range determination unit 110, that is, the movement distance or movement time necessary for the vehicle 2 to arrive at the repair place from the current location. In order to reliably prevent a failure of the vehicle 2 during driving, the threshold may be set to a value obtained by adding a predetermined value to the reference movement range. As a result, it is possible to provide a sufficient margin to reliably prevent a failure of the vehicle 2 during driving.

Here, an example of determination of the movable range will be described below. For example, when the threshold of the movable range is 25 km, and the movable range is 50 km, the movable range (50 km) is longer than the threshold (25 km). Therefore, the movable range determination unit 110 determines that the reserved repair is located within the movable range. Note that the method and values described here are merely an example, and the invention is not limited thereto.

The movable range determination unit 110 generates a determination display screen for displaying the determination result. The determination display screen includes the determination result, the movable range, the location of the repair place, the travel route to the repair place, and the reference movement range required to reach the repair place. The transmission unit 100 transmits a control signal for displaying the determination display screen generated by the movable range determination unit 110 to the vehicle 2 and/or external terminal 3.

In addition, if it is determined that the reserved repair place is not located within the movable range, the vehicle cannot move to the reserved repair place, so that the movable range determination unit 110 generates a determination display screen further including additional instruction information for instructing to change the reservation to another repair place. In addition, in this case, the movable range determination unit 110 cancels the reservation of the reserved repair place. In addition, if it is determined that the reserved repair place is not located within the movable range, the server 1 re-executes the process of transmitting repair place data for the repair place described in the first embodiment. That is, the server 1 extracts a destination located within the movable range at the time it is determined that the reserved repair place is not located within the movable range, and acquires a repair place candidate located within the movable range of the destination. In addition, the server 1 computes the influence level of the repair place candidate, determines the priority of the repair place candidate on the basis of the influence level, and transmits the repair place data of the repair place candidate along with the priority to the vehicle 2 and/or external terminal 3.

In addition, if the movable range determination unit 110 determines that the reserved repair place is located within the movable range, it performs determination using the movable range again after a certain period of time. That is, the movable range determination unit 110 repeatedly performs determination using the movable range periodically.

As a result, it is possible to prevent the vehicle from being unable to arrive at the repair place due to a discrepancy between the route in the travel schedule and the actual travel route caused by a change in the schedule or the like. In addition, even when the actual travel route changes due to the schedule changed by the user, it is possible to provide the user with a repair place candidate that minimizes the influence on the schedule again.

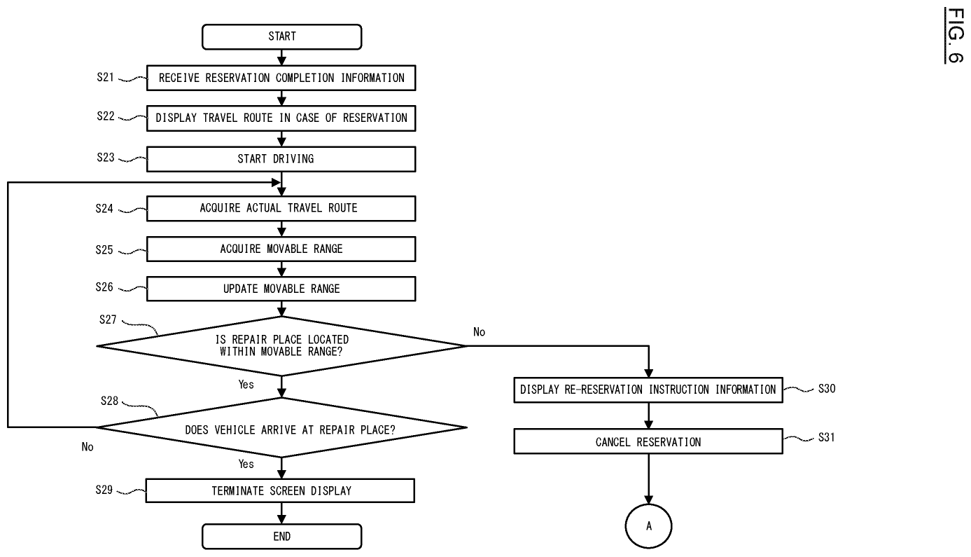

Next, the repair place transmission method executed by the repair place transmission device according to the fifth embodiment will be described with reference to FIG. 6. FIG. 6 is a flow chart illustrating a sequence of the repair place transmission method according to the fifth embodiment. The fifth embodiment is an example of the repair place transmission method after the user confirms the reservation of the repair place. When the user confirms the reservation of the repair place, the server 1 starts the control flow from step S21.

In step S21, the server 1 receives reservation completion data indicating that the user has completed the reservation of the repair place from the vehicle 2 and/or external terminal 3. The reservation completion data includes the repair place data of the repair place reserved by the user.

In step S22, the server 1 displays the travel route at the time of reservation confirmation. The travel route at the time of reservation confirmation is the route from the current location to the reserved repair place. When there is a destination passing through before arriving at the repair place, the travel route at the time of reservation includes location data of that destination. First, the server 1 generates a travel route at the time reservation confirmation on the basis of the schedule of the user or vehicle 2, the location of the repair place reserved by the user, and the current location. In addition, in this case, the server 1 acquires the reference movement range necessary to travel from the current location to the repair place from the travel route. In addition, the server 1 acquires the movable range at the time of reservation confirmation for the repair place. Furthermore, the server 1 transmits a control signal for displaying the travel route, the reference movement range, and the movable range at the time of reservation confirmation to the vehicle 2 and/or external terminal 3. When the vehicle 2 and/or external terminal 3 receives this control signal, it displays the travel route, the reference movement range, and the movable range at the time of reservation confirmation on the display.

In step S23, the vehicle 2 starts driving along the travel route to the repair place. In step S24, the server 1 acquires the actual travel route that the vehicle 2 actually travels. For example, the server 1 acquires location information of the vehicle 2 periodically, stores it as time series data, and acquires a location trajectory of the vehicle 2 as the actual travel route driven by the vehicle 2 up to that time point.

In step S25, the server 1 acquires the movable range at that time point.

In step S26, the server 1 transmits, to the vehicle 2 and/or external terminal 3, a control signal for updating the movable range displayed on the display of the vehicle 2 and/or external terminal 3 to the movable range acquired in step S25. The vehicle 2 and/or external terminal 3 updates the movable range displayed on the display to the movable range acquired in step S25.

In step S27, the server 1 determines whether or not the repair place is located within the movable range. For example, the server 1 compares the movable range at that time point with the reference movement range necessary to arrive at the repair place from the current location at that time point. When the movable range is equal to or longer than the reference movement range, it is determined that the repair place is located within the movable range. If it is determined that the repair place is located within the movable range, the server 1 proceeds to step S28. If it is determined that the vehicle 2 cannot arrive at the repair place, the server 1 proceeds to step S30. In step S30, the server 1 transmits, to the vehicle 2 and/or external terminal 3, a control signal for outputting re-reservation instruction information instructing the user to re-book a repair place within the movable range. When the vehicle 2 and/or external terminal 3 receives this control signal, it displays the re-reservation instruction information on the display. In step S31, the server 1 cancels the reservation of the reserved repair place. After canceling the reservation, the server 1 proceeds to step S7 in FIG. 3 and processes the control flow relating to the repair place transmission method from step S7.

In step S28, the server 1 determines whether or not the vehicle 2 arrives at the repair place on the basis of the current location of the vehicle 2 and the location of the repair place. If it is determined that the vehicle 2 arrives at the repair place, the server 1 proceeds to step S29. In step S29, the server 1 closes the screen displaying the repair place. If it is determined that the vehicle 2 does not arrive at the repair place, the server 1 returns to step S24 and repeats the flow below. That is, according to this embodiment, while the vehicle is driven to the repair place, the server 1 acquires the current location of the vehicle 2 periodically and acquires the travel route traveled by the vehicle 2 up to that time point. Furthermore, the server 1 acquires the remaining movable range on the basis of the actual travel route of the vehicle 2 and determines whether or not the vehicle 2 can arrive at the repair place before a failure.

In addition, according to this embodiment, when the vehicle 2 moves away from the travel route to the repair place, the movable range determination unit 110 generates warning information indicating that the vehicle 2 may not be able to move to the repair place. The transmission unit 100 transmits a control signal for outputting warning information to the vehicle 2 and/or external terminal 3.

First, the movable range determination unit 110 determines whether or not the vehicle 2 leaves the travel route to the repair place on the basis of the current location of the vehicle 2 and the travel route to the repair place. If it is determined that the vehicle 2 leaves the travel route to the repair place, the movable range determination unit 110 computes a deviation level indicating a distance between the travel route to the repair place and the current location. For example, the movable range determination unit 110 computes a distance from the place where the vehicle 2 leaves the travel route to the current location as the deviation level. If it is determined that the vehicle 2 does not leave the travel route to the repair place, the movable range determination unit 110 determines again whether or not the vehicle 2 leaves the travel route to the repair place after a predetermined period of time. That is, the movable range determination unit 110 determines whether or not the vehicle 2 leaves the travel route to the repair place periodically.

Then, the movable range determination unit 110 determines whether or not the deviation level is equal to or higher than a predetermined threshold. If the deviation level is determined to be equal to or higher than the predetermined threshold, the movable range determination unit 110 generates a warning screen indicating that the vehicle 2 may not be able to move to the repair place. When the warning screen is generated, the transmission unit 100 transmits a control signal for outputting the warning screen to the vehicle 2 and/or external terminal 3. If it is determined that the deviation level is not higher than the predetermined threshold, the movable range determination unit 110 determines again whether the deviation level is higher than the predetermined threshold after a predetermined time has elapsed. In other words, the movable range determination unit 110 determines, periodically, whether the deviation level is above a predetermined threshold.

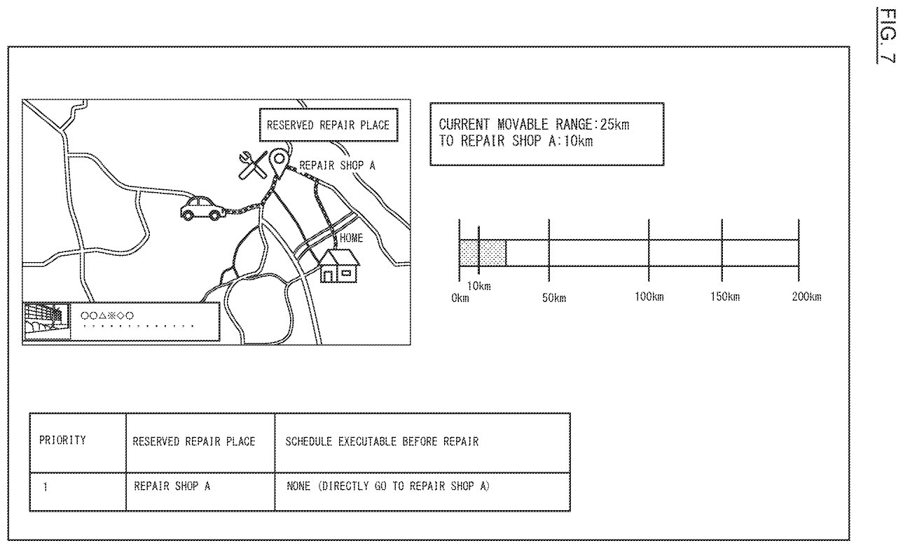

Next, a display example displayed on the display of the vehicle 2 and/or external terminal 3 according to the fifth embodiment will be described with reference to FIGS. 7 to 9. FIG. 7 is an example of a display screen for displaying the movable range. The display screen of FIG. 7 is a screen displayed on the display of the vehicle 2 and/or external terminal 3 while the vehicle 2 is driven to the repair place after the user confirms the reservation. The display displays the movable range, the location of the reserved repair place, the route to the reserved repair place, and the reference movement distance. In FIG. 7, the current movable range is 25 km, the reserved repair place is a repair shop A, and the reference movement distance to the repair shop A is 10 km.

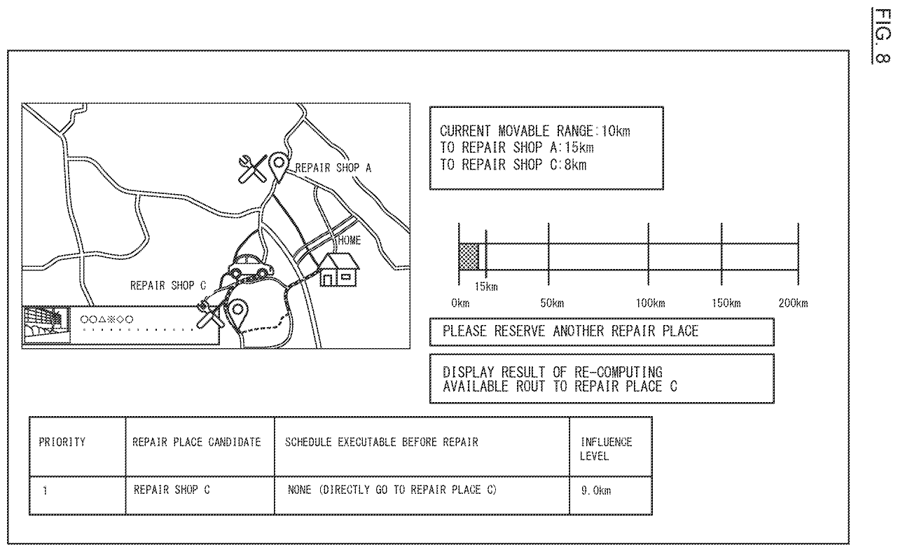

FIG. 8 is an example of a display screen when the movable range is shorter than the reference movement distance. In FIG. 8, the display screen appears when the movable range becomes shorter than the reference movement distance while the vehicle 2 is driven to the repair place. In FIG. 8, the movable range is 10 km, the reference movement distance to the repair shop A is 10 km, and the reference movement distance to the repair shop C is 8 km. On the display screen, information indicating that the movable range is shorter than the reference movement distance is displayed. In addition, text data or graphic data including re-reservation instruction information for urging the user to make reservation again and information indicating other repair place candidates are displayed on the display screen.

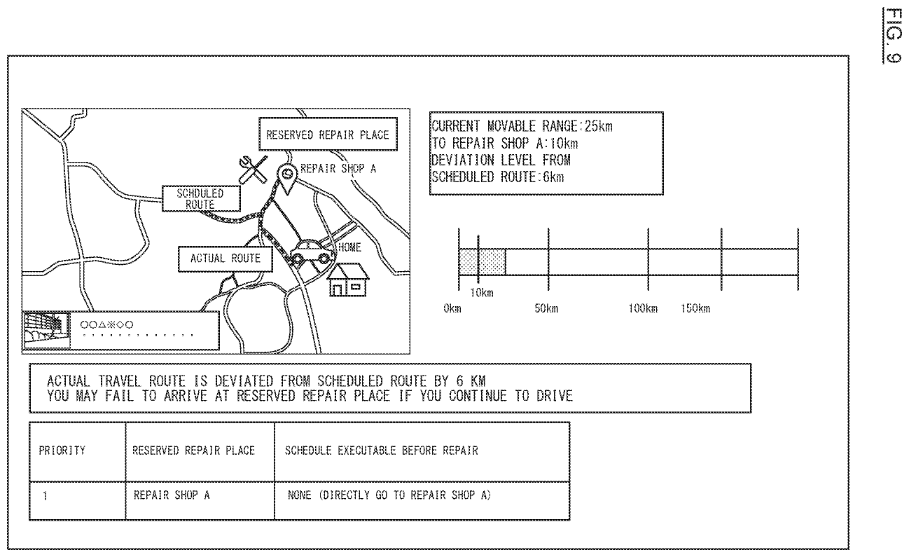

FIG. 9 is a display screen displayed in the case where the vehicle 2 leaves the scheduled route, and the actual travel route is deviated from the scheduled route while the vehicle 2 is driven to the repair place. The display screen displays the current movable range, the distance to the reserved repair place, the deviation level from the scheduled route of the vehicle, the scheduled route, and the actual route. The scheduled route is a route from the place where the user confirmed the reservation of the repair place to the reserved repair place (repair shop A). The actual route is a route from the place separated from the scheduled route to the current location of the vehicle. In addition, warning information indicating that the travel route of the vehicle is deviated from the scheduled route is displayed on the display screen.

In addition, according to this embodiment, the server 1 transmits a control signal for outputting the movement schedule to the vehicle 2 and/or external terminal 3. The movement schedule may be a movement schedule acquired from the originally scheduled schedule, or may be a movement schedule in which the vehicle 2 stops by the repair place. First, the route guidance unit 90 generates a display screen for displaying the movement schedule. In addition, the transmission unit 100 transmits a control signal for displaying the display screen generated by the route guidance unit 90 to the vehicle 2 and/or external terminal 3. In addition, the route guidance unit 90 acquires movement schedule change information from the vehicle 2 and/or external terminal 3. The change information includes, for example, a change of the destination and/or a change of the estimated arrival time. The route guidance unit 90 changes the movement schedule on the basis of the acquired change information and generates a display screen for displaying the changed movement schedule. The transmission unit 100 transmits a control signal for outputting the changed movement schedule to the vehicle 2 and/or external terminal 3.

For example, in the original movement schedule, assuming that the destination is a supermarket, a hospital, and a home, the display screen displays a movement schedule including the supermarket as a first destination, the hospital as a second destination, and the home as a third destination. In addition, when the user makes a change to exclude the supermarket from the destination, the changed movement schedule including the hospital as the first destination and the home as the second destination is displayed on the display screen. In this case, a selection screen is displayed to confirm whether or not to change the movement schedule, along with the changed movement schedule. Furthermore, the original movement schedule before the change and the movement schedule after the change may also be displayed at the same time.

In addition, when the movement schedule changes while vehicle 2 is driven to the repair place, the server 1 transmits repair place data of the repair place candidate including the influence level on the basis of the changed movement schedule. For example, the travel route extraction unit 50 extracts the travel route from the current location to the destination from the changed movement schedule. The repair place extraction unit 60 extracts a plurality of repair places within a predetermined range from the changed travel route. In addition, the influence level computation unit 70 computes the influence level for each repair place.

In addition, after the user confirms the reservation of the repair place, if the movable distance or movable time becomes equal to or shorter than the predetermined distance or time due to an event other than a failure caused by a vehicle abnormality, the server 1 changes the movement schedule. Events other than the failure caused by a vehicle abnormality include, for example, refueling, charging, and repair of accidental failures that are not subject to abnormality detection. The accidental failures include, for example, a broken window or the like. In addition, when the movement schedule is changed, the server 1 extracts the changed travel route from the current location to the destination on the basis of the changed movement schedule, extracts a plurality of repair places with a predetermined range from the changed travel route, and computes the influence level for each repair place.

When the movement schedule is changed due to an event other than a failure caused by a vehicle abnormality, then the server 1 displays the changed movement schedule on the vehicle 2 and/or external terminal 3. For example, it is assumed that the movement schedule before the change includes a hospital as a first destination and a home as a second destination. When refueling is necessary, the server 1 generates a changed movement schedule that includes a gas station as the destination. The server 1 displays the changed movement schedule, including the gas station as the first destination, the hospital as the second destination, and the home as the third destination. In addition, the server 1 displays a selection screen for confirming whether or not to change the movement schedule along with the changed movement schedule.

As described above, according to this embodiment, when the user confirms the reservation of the repair place, a movable distance or movable time by which the vehicle can move before a failure caused by a vehicle abnormality occurs until arriving at the reserved repair place is estimated, and a control signal for outputting the movable distance or movable time is transmitted. As a result, it is possible to allow the user to determine in real time whether or not the vehicle can move to the repair place while the vehicle is driven.

In addition, according to this embodiment, the movable distance or movable time, and the movement distance or movement time from the current location to the reserved repair place are computed periodically, and it is determined whether not the reserved repair place is located with the movable distance or movable time range on the basis of the movable distance or movable time and the movement distance or movement time from the current location to the reserved repair place. If it is determined that the reserved repair place is not located within the movable distance or movable time, the reservation of the reserved repair place is canceled, the repair place is extracted within the movable distance or movable time, and a control signal for outputting repair place data on the extracted repair place is transmitted. As a result, even when the vehicle is unable to arrive at the repair place during driving to the repair place, it is possible to provide the user with information on a repair place within the movable range.

In addition, according to this embodiment, when the vehicle leaves the travel route to the repair place, a deviation level indicating the distance between the travel route to the repair place and the current location is computed, and it is determined whether or not the deviation level is equal to or higher than a predetermined threshold. If the deviation level is determined to be equal to or higher than the predetermined threshold, a warning screen indicating that the vehicle may not be able to move to the reserved repair place is generated, and a control signal for outputting the warning screen is transmitted. As a result, it is possible to prevent the vehicle from failing to move to the repair place due to separation from the travel route to the repair place.

In addition, according to this embodiment, a control signal for outputting the movement schedule is transmitted, the movement schedule change information is acquired, the movement schedule is changed on the basis of the change information, and a control signal for outputting the changed movement schedule is transmitted. As a result, when the user changes the movement schedule, it is possible to provide the user with information on the changed movement schedule.

In addition, according to this embodiment, when the movement schedule is changed, the changed travel route from the current location to the destination is extracted from the changed movement schedule, a plurality of repair places are extracted within a predetermined range from the changed travel route, and the influence level for each repair place is computed. As a result, when the user changes the movement schedule, it is possible to provide the user with information on the repair place while suppressing the influence of vehicle repair on the changed movement schedule.

In addition, according to this embodiment, when the user confirms the reservation of the repair place, and then, the movable distance or movable time for moving the vehicle becomes equal to or shorter than a predetermined distance or time due to an event other than a failure caused by a vehicle abnormality, the movement schedule is changed. When the movement schedule is changed, the changed travel route from the current location to the destination is extracted from the changed movement schedule, a plurality of repair places are extracted within a predetermined range from the changed travel route, and the influence level is computed for each repair place is. As a result, even when the movement schedule is changed due to an accidental event that narrows the vehicle movement range, it is possible to provide the user with information on the repair place while suppressing influence of the vehicle repair on the changed movement schedule.

### Sixth Embodiment

Next, a sixth embodiment of the present invention will be described. The sixth embodiment is a modification of the fourth embodiment. The sixth embodiment has a configuration similar to that of the fourth embodiment and operates similarly to the fourth embodiment except that the repair place transmission device of the sixth embodiment is different from that of the fourth embodiment as described below. Therefore, the description of the fourth embodiment will be appropriately referred to. Hereinafter, a configuration different from that of the fourth embodiment will be described. The configuration of this embodiment is different from that of the fourth embodiment in that the repair place suggestion unit 80 further has an alternative movement means arrangement function. The repair place suggestion unit 80 arranges a movement means for allowing the user to move along a movement route between the repair place and the nearest destination from the repair place, instead of the vehicle 2 as a repair target. The repair place suggestion unit 80 of this embodiment corresponds to an alternative movement means arrangement unit according to the present invention.

When the user confirms the reservation of the repair place, the repair place suggestion unit 80 searches for an available alternative vehicle substituting the vehicle 2 on the basis of the estimated arrival time at the destination, and generates suggestion information that presents a suggestion for the searched alternative vehicle. The alternative vehicle is, for example, a substitute vehicle provided by the reserved repair shop. The repair place suggestion unit 80 checks whether or not there is an alternative vehicle available at the reserved repair place to arrive at the destination at the estimated arrival time. If it is determined that there is an alternative vehicle at the reserved repair place, the repair place suggestion unit 80 generates suggestion information. In addition, the alternative vehicle may be a taxi or a dispatch vehicle provided by a dispatch service provider. The repair place suggestion unit 80 checks whether or not the taxi operator or dispatch service provider has an alternative vehicle available to arrive at the destination at the estimated arrival time. The transmission unit 100 transmits a control signal for outputting suggestion information to the vehicle 2 and/or external terminal 3. When the vehicle 2 and/or external terminal 3 receives the control signal for outputting the suggestion information, the suggestion information is displayed on the display.

If it is determined that there is no alternative vehicle at the reserved repair place, the repair place suggestion unit 80 acquires movement means data regarding another movement means for allowing the user to move along a movement route between the reserved repair place and the nearest destination from the reserved repair place. Another movement means includes a train, bus, or walking. For example, the repair place suggestion unit 80 searches for an available movement means on the movement route between the repair place and the destination. In this case, the repair place suggestion unit 80 acquires the movement route and the movement time necessary for the user to move along the movement route for each movement means. The number of movement means may be singular, or a plurality of movement means may be combined. The transmission unit 100 transmits a control signal for outputting the movement means, the movement route, and the movement time to the vehicle 2 and/or external terminal 3. When this control signal is received, the vehicle 2 and/or external terminal 3 displays the movement means, the movement route, and movement time on the display.

When the user decides to use an alternative vehicle of the repair place, the repair place suggestion unit 80 contacts the repair place to make a reservation for use of the alternative vehicle. In addition, when the user decides to use a taxi or a dispatch vehicle, the repair place suggestion unit 80 contacts a taxi operator or dispatch service provider to move the alternative vehicle that can arrive at the repair place to the repair place before the user arrives at the repair place.

In addition, when the user confirms the reservation of the repair place, the repair place suggestion unit 80 determines whether or not a wrecker towing service for towing the vehicle 2 using a wrecker is necessary to move the vehicle 2 to the reserved repair place. If it is determined that the wrecker towing is necessary, the repair place suggestion unit 80 contracts a wrecker service provider to arrange a wrecker. For example, when the repair place located closest to the current location is placed outside the movable range, the repair place suggestion unit 80 determines that the wrecker towing is necessary.

In addition, the repair place suggestion unit 80 sets a meeting place where the vehicle 2 and the wrecker meet as a destination, and acquires a travel route from the current location to the meeting place. The transmission unit 100 transmits, to the vehicle 2 and/or external terminal 3, a control signal for outputting the meeting place where the wrecker and the vehicle 2 meet and the travel route from the current location to the meeting place. When this control signal is received, the vehicle 2 and/or external terminal 3 displays the travel route from the current location to the meeting place on the display.

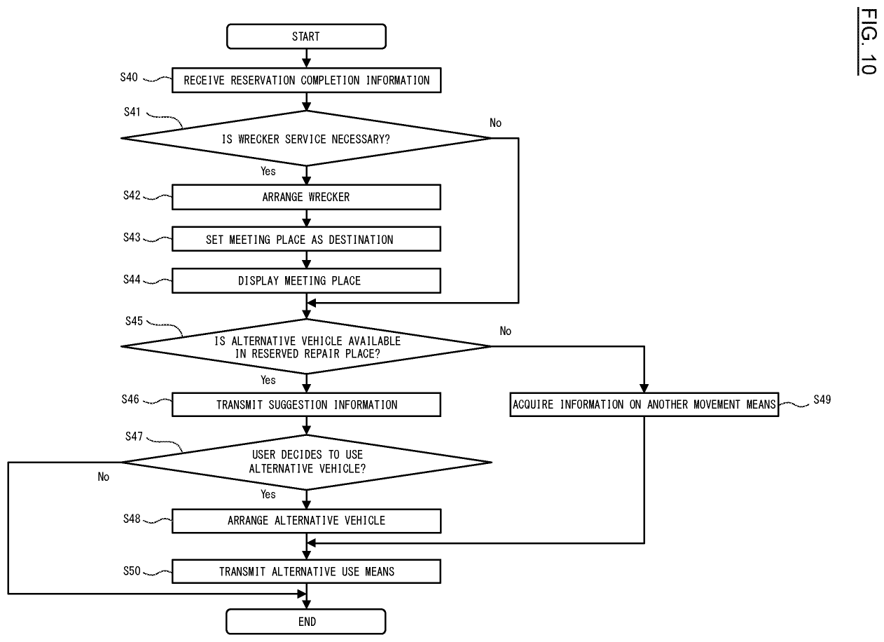

Next, a repair place transmission method executed by a repair place transmission device according to the sixth embodiment will be described with reference to FIG. 10. FIG. 10 is a flow chart illustrating a sequence of the repair place transmission method according to the sixth embodiment. The sixth embodiment is an example of control after the user confirms the reservation of the repair place. After the user confirms the reservation of the repair place, the server 1 starts a control flow from step S40.

In step S40, the server 1 receives, from the vehicle 2 and/or external terminal 3, the reservation completion information indicating that the user has completed the reservation of the repair place. The reservation completion information includes the repair place data of the repair place reserved by the user.

In step S41, the server 1 determines whether or not towing of the vehicle 2 using a wrecker is necessary. If it is determined that towing of the vehicle 2 using a wrecker is necessary, the server 1 proceeds to step S42. If it is determined that towing of the vehicle 2 using a wrecker is not necessary, the server 1 proceeds to step S45.

In step S42, the server 1 requests a wrecker service provider to arrange a wrecker. In step S43, the server 1 specifies a meeting place where the wrecker and the vehicle 2 meet and sets the meeting place as the destination. In step S44, the server 1 transmits a control signal for displaying the meeting place to the vehicle 2 and/or external terminal 3. When the vehicle 2 and/or external terminal 3 receives the control signal, the meeting place is displayed on the display.

In step S45, the server 1 determines whether or not there is an alternative vehicle at the reserved repair place. If it is determined that there is an alternative vehicle at the reserved repair place, the server 1 proceeds to step S46. If it is determined that there is no alternative vehicle at the reserved repair place, the server 1 proceeds to step S49. In step S46, the server 1 transmits a control signal for displaying suggestion information for suggesting use of the alternative vehicle to the vehicle 2 and/or external terminal 3. When the vehicle 2 and/or external terminal 3 receives the control signal, the suggested information is displayed on the display.

In step S47, the server 1 determines whether or not the user has decided to use the alternative vehicle. When the server 1 receives the use decision information from the vehicle 2 and/or external terminal 3, it is determined that the user has decided to use an alternative vehicle. If it is determined that the user has decided to use the alternative vehicle, the server 1 proceeds to step S48. If the server 1 does not receive the use decision information, it is determined that the user does not use the alternative vehicle. If it is determined that the user does not use the alternative vehicle, the server 1 terminates the control flow.

In step S48, the server 1 arranges an alternative vehicle. For example, the server 1 makes a reservation for use of the alternative vehicle at the repair place. In step S49, the server 1 acquires information on another movement means. In step S50, the server 1 transmits a control signal for displaying information on the alternative vehicle arranged in step S208 or information on other movement means obtained in step S209 to the vehicle 2 and/or external terminal 3. The vehicle 2 and/or external terminal 3 displays information on the received alternative vehicle or information on another movement means on the display.

As described above, according to this embodiment, when the user confirms the reservation of the repair place, an alternative vehicle that can be used instead of the vehicle is searched on the basis of the arrival time at the destination, suggestion information for suggesting the searched alternative vehicle is generated, and a control signal for outputting the suggestion information is transmitted. As a result, even when the vehicle is repaired at the repair place, it is possible to provide the user with information on the alternative vehicle that can be used to move to the destination.

In addition, according to this embodiment, when the user decides to use an alternative vehicle, the dispatch service provider is contacted to move the alternative vehicle that can arrive at the reserved repair place before the user's arrival to the repair place. As a result, it is possible to allow the user to move to the destination on the user's schedule.

In addition, according to this embodiment, when the user confirms the reservation of the repair place, movement means data of the movement means for allowing the user to move along the movement route between the reserved repair place and the nearest destination from the reserved repair place is acquired. In addition, a control signal for outputting movement means data, a movement route, and a movement time necessary for the user to move along the movement route using the movement means is transmitted. As a result, it is possible to allow the user to know the movement means for moving from the repair place to the destination.

In addition, according to this embodiment, it is determined whether or not a wrecker service is necessary to move the vehicle to the reserved repair place. When it is determined that a wrecker service is necessary, a meeting place where the wrecker and the vehicle meet is specified, and a control signal for outputting a travel route from the current location to the meeting place is transmitted. As a result, when a wrecker is necessary, the user can know the meeting place for the wrecker.

Note that the embodiments described above are described to facilitate understanding of the present invention, and are not described to limit the present invention. Therefore, each element disclosed in the above embodiments is intended to include all design changes and equivalents that fall within the technical scope of the present invention.

### DESCRIPTION OF REFERENCE NUMERALS

1000 repair place transmission device
1 server
10 storage unit
20 location acquisition unit
30 movement schedule acquisition unit
40 abnormality determination unit
50 travel route extraction unit
60 repair place extraction unit
70 influence level computation unit
80 repair place suggestion unit
90 route guidance unit
100 transmission unit
2 vehicle
3 external terminal

1. A repair place transmission device configured to:
acquire a movement schedule for moving a user to a destination using a vehicle;
acquire a current location of the vehicle;
an abnormality determination unit configured to determine whether or not an abnormality is present in the vehicle;
extract, from the movement schedule, a travel route from the current location to the destination and a plurality of destinations located on the travel route;
extract, for each of the destinations, repair place for repairing the vehicle located within a predetermined range from the destination as the repair place corresponding to the destination when the abnormality is determined to be present in the vehicle;
compute, for each of the repair places, an influence level indicating a level of influence on the movement schedule by repairing the vehicle in the repair place; and
transmit a control signal for outputting repair place data on the repair place having a lower influence level in priority over repair place data on the repair place having a higher influence level.

2. The repair place transmission device according to claim 1, further configured to:
for each of the destinations, acquire a staying time of the user at the destination;
for each of the repair places, acquire a repair time necessary to repair the vehicle;
for each of the destinations, compare the staying time at the destination with the repair time in the repair place corresponding to the destination; and
compute the influence level of the repair place having the repair time longer than the staying time to be higher than the influence level of the repair place having the repair time shorter than the staying time.

3. The repair place transmission device according to claim 1, further configured to:
acquire a desired arrival time to the destination desired by the user;
for each of the repair places, compute an estimated arrival time at which the vehicle arrives at the destination via the repair place;
for each of the repair places, compute a delay time for the desired arrival time on the basis of the estimated arrival time and the desired arrival time; and
compute the influence level of the repair place having the longer delay time to be higher than the influence level of the repair place having the shorter delay time.

4. The repair place transmission device according to claim 1, further configured to:
extract, from the movement schedule, a first travel distance for moving the vehicle from the current location to the destination;
compute, for each of the repair places, a second travel distance for moving the vehicle from the current location to the destination via the repair place;
compare, for each of the repair places, the first travel distance and the second travel distance; and
compute the influence level of the repair place having a larger distance difference between the first travel distance and the second travel distance to be higher than the influence level of the repair place having a smaller distance difference between the first travel distance and the second travel distance.

5. (canceled)

6. The repair place transmission device according to claim 1, wherein the predetermined range is a distance or time range computed by subtracting a movement distance or movement time from the current location to a predetermined place on the travel route from a movable distance or movable time by which the vehicle is allowed to move until a failure caused by an abnormality of the vehicle occurs.

7. The repair place transmission device according to claim 1, further configured to extract the repair place within the movable distance or movable time by which the vehicle is allowed to move until a failure caused by an abnormality of the vehicle occurs.

8. The repair place transmission device according to claim 1, further configured to:
generate route guidance information including a travel route from the current location to the repair place and a travel route from the repair place to the destination; and
transmit a control signal for outputting the route guidance information.

9. The repair place transmission device according to claim 8, further configured to:
when the user selects the repair place to be stopped by among a plurality of the output repair places, generate a reservation screen for reserving the selected repair place, and
transmit a control signal for outputting the reservation screen.

10. The repair place transmission device according to claim 9, further configured to:
compute a reservation time for repair of the vehicle on the basis of an estimated arrival time at which the vehicle arrives at the selected repair place, and
transmit a control signal for outputting the reservation time on the reservation screen.

11. The repair place transmission device according to claim 9, further configured to:
when the user confirms a reservation of the repair place, estimate the movable distance or movable time by which the vehicle is allowed to move before a failure caused by an abnormality of the vehicle occurs until arriving at the reserved repair place; and
transmit a control signal for outputting the movable distance or movable time.

12. The repair place transmission device according to claim 11, further configured to:
compute the movable distance or the movable time and the movement distance or the movement time from the current location to the reserved repair place periodically;
determine whether or not the reserved repair place is located within the movable distance or the movable time range on the basis of the movable distance or the movable time and the movement distance or the movement time from the current location to the reserved repair place;
cancel the reservation of the repair place when the reserved repair place is determined not to be located within the movable distance or the movable time range;
extract the repair place within the movable distance or the movable time range; and
transmit a control signal for outputting the repair place data on the extracted repair place.

13. The repair place transmission device according to claim 11, further configured to:
compute a deviation level indicating a distance between the travel route to the repair place and the current location when the vehicle leaves the travel route to the repair place;
determine whether or not the deviation level is equal to or higher than a predetermined threshold;
when the deviation level is determined to be equal to or higher than the predetermined threshold, generate a warning screen indicating that the vehicle is likely to fail to move to the reserved repair place; and
transmit a control signal for outputting the warning screen.

14. The repair place transmission device according to claim 1, further configured to:
transmit a control signal for outputting the movement schedule,
acquire change information of the movement schedule;
change the movement schedule on the basis of the change information; and
transmit a control signal for outputting the changed movement schedule.

15. The repair place transmission device according to claim 14, further configured to:
extract the changed travel route from the current location to the destination from the changed movement schedule when the movement schedule is changed;
extract a plurality of the repair places within the predetermined range from the changed travel route; and
compute the influence level for each of the repair places.

16. The repair place transmission device according to claim 1, further configured to:
change the movement schedule when the movable distance or the movable time by which the vehicle is allowed to move becomes equal to or shorter than a predetermined distance or time due to an event other than the failure caused by the abnormality of the vehicle after the user confirms the reservation of the repair place;
when the movement schedule is changed, extract a changed travel route from the current location to the destination from the changed movement schedule;
extract a plurality of the repair places within the predetermined range from the changed travel route; and
compute the influence level for each of the repair places.

17. The repair place transmission device according to claim 1, further configured to:
specify a replacement item necessary to repair the vehicle;
extract the repair place on the basis of an inventory status of the replacement item and a period of time necessary to obtain the replacement item in each of the repair places; and
compute the influence level of the repair place on the basis of the inventory status of the replacement item and the period of time necessary to obtain the replacement item in each of the repair places.

18. The repair place transmission device according to claim 17, further configured to: transmit a control signal for outputting replacement item data on the specified replacement item.

19. The repair place transmission device according to claim 9, further configured to:
arrange an available movement means instead of the vehicle;
search for an alternative vehicle that is allowed to be used instead of the vehicle on the basis of an arrival time at the destination when the user confirms the reservation of the repair place;
generate suggestion information for suggesting the searched alternative vehicle; and
transmit a control signal for outputting the suggestion information.

20. The repair place transmission device according to claim 19, further configured to:
when the user decides to use the alternative vehicle, contact a dispatch service provider to move, to the repair place, the alternative vehicle that is allowed to arrive at the reserved repair place before the user arrives.

21. The repair place transmission device according to claim 19, further configured to:
when the user confirms a reservation of the repair place, acquire movement means data on a movement means for moving the user along a movement route between the reserved repair place and the destination closest to the reserved repair place; and
transmit a control signal for outputting the movement means data, the movement route, and a movement time necessary for the user to move along the movement route using the movement means.

22. The repair place transmission device according to claim 19, further configured to:
determine whether or not a wrecker service is necessary to move the vehicle to the reserved repair place;
when the wrecker service is determined to be necessary, specify a meeting place where a wrecker and the vehicle meet; and
transmit a control signal for outputting a travel route from the current location to the meeting place.

23. A repair place transmission method executed by a server, the server configured to:
acquire a movement schedule for moving a user to a destination using a vehicle;
acquire a current location of the vehicle;
extract, from the movement schedule, a travel route from the current location to the destination and a plurality of destinations located on the travel route;
determine whether or not an abnormality is present in the vehicle;
when the abnormality is determined to be present in the vehicle, extract, for each of the destinations, a repair place for repairing the vehicle located within a predetermined range from the destination as the repair place corresponding to the destination;
compute, for each of the repair places, an influence level indicating a level of influence on the movement schedule by repairing the vehicle at the repair place; and
transmitting a control signal for outputting repair place data on the repair place having a lower influence level in priority over repair place data on the repair place having a higher influence level.
